(19) United States
(12) Patent Application Publication
(10) Pub. No.: US 2024/0292451 A1
(43) Pub. Date: Aug. 29, 2024

(54) Random Access in a Wireless Communication Network

(71) Applicant: Telefonaktiebolaget LM Ericsson (publ), Stockholm (SE)

(72) Inventor: Min Wang, Luleå (SE)

(21) Appl. No.: 18/574,575

(22) PCT Filed: Jun. 29, 2022
(86) PCT No.: PCT/EP2022/067852

§ 371 Date: Dec. 27, 2023

Related U.S. Application Data
(60) Provisional application No. 63/217,059, filed on Jun. 30, 2021.

(51) Int. Cl. H04W 74/00

(52) U.S. Cl. CPC H04W 74/008; H04W 74/006

(57) ABSTRACT

A wireless communication device (12) computes a random access identifier (20) associated with a random access channel occasion (18). The wireless communication device (12) in particular computes the random access identifier (20) as a function of an index of the first slot (32) of the random access channel occasion (18) in a system frame (24). In some embodiments, the subcarrier spacing used to determine the index (30) is different than a subcarrier spacing of the random access channel occasion (18). Regardless, the wireless communication device (12) transmits a random access message (16) using the random access channel occasion (18) and the computed random access identifier (20).

### TECHNICAL FIELD

The present application relates generally to a wireless communication network, and relates more particularly to random access in such a network.

### BACKGROUND

To perform random access to a cell in a wireless communication network, a wireless communication device transmits a random access message, e.g., MSG1 of a 4-step random access procedure or MSGA of a 2-step random access procedure. The random access message may for instance convey a random access preamble. In this regard, a wireless communication device computes a random access identifier, e.g., in the form of a random access radio network temporary identifier (RA-RNTI). If the random access transmission from the wireless communication device can be received by the wireless communication network, the network will reply with a random access response on a downlink control channel addressed to the random access identifier. In this way, the transmission of the random access preamble is identified by the network.

Known approaches to random access support a subcarrier spacing up to 120 kHz. For example, to account for a 120 kHz subcarrier spacing, the RA-RNTI may be computed as a function of which slot among the 80 slots in a system frame contains the random access channel occasion. However, if the subcarrier spacing is higher than 120 kHz, there may be more than 80 slots in a system frame. Using known approaches, therefore, means that the RA-RNTI would fail to distinguish between multiple random access channel attempts by different wireless communication devices using a subcarrier spacing higher than 120 kHz, e.g., 240 kHz, 480 kHz or 960 kHz.

Known approaches also fail to accommodate for use of multiple subcarrier spacings for random access in the same cell.

### SUMMARY

Some embodiments herein support random access to a wireless communication network using a higher subcarrier spacing than that supported by known approaches. Alternatively or additionally, some embodiments herein accommodate for the use of multiple subcarrier spacings for random access in the same cell.

More particularly, according to some embodiments, a wireless communication device computes a random access identifier associated with a random access channel occasion. The wireless communication device computes the random access identifier as a function of an index of the first slot of the random access channel occasion in a system frame. In some embodiments, the possible values for the index include values greater than or equal to 80, e.g., to distinguish between slots where the system frame includes more than 80 slots. In other embodiments, the subcarrier spacing used to determine the index is different than a subcarrier spacing of the random access channel occasion. Regardless, the wireless communication device may transmit a random access message using the random access channel occasion and the computed random access identifier.

Alternatively or additionally, a wireless communication device selects, from among multiple subcarrier spacings configured for random access to a cell in the wireless communication network, a subcarrier spacing with which to perform random access to the cell. The wireless communication device performs random access to the cell using the selected subcarrier spacing.

More particularly, embodiments herein include a method performed by a wireless communication device configured for use in a wireless communication network. The method comprises computing a random access identifier associated with a random access channel occasion as a function of an index of the first slot of the random access channel occasion in a system frame. In some embodiments, a subcarrier spacing used to determine the index is different than a subcarrier spacing of the random access channel occasion. The method also comprises transmitting a random access message using the random access channel occasion and the computed random access identifier.

In some embodiments, the subcarrier spacing used to determine the index is smaller than a subcarrier spacing of the random access channel occasion.

In some embodiments, a subcarrier spacing used to determine the index is 120 kHz.

In some embodiments, said computing comprises computing the random access identifier as 1+s_id+14×t_id+14×80×f_id+14×80×8×ul_carrier_id. In this case, s_id is an index of the first Orthogonal Frequency Division Multiplexing, OFDM, symbol of the random access channel occasion, t_id is the index of the first slot of the random access channel occasion in a system frame, f_id is an index of the random access channel occasion in the frequency domain, and ul_carrier_id is an uplink carrier used for random access preamble transmission.

In some embodiments, the subcarrier spacing used to determine the index is smaller than a subcarrier spacing of the random access channel occasion. In some embodiments, the first slot, from among multiple slots with the subcarrier spacing used to determine the index, that contains the random access channel occasion spans multiple slots with the subcarrier spacing of the random access channel occasion. In one or more of these embodiments, said computing comprises computing the random access identifier as a function also of an index of the first slot, from among the multiple slots with the subcarrier spacing of the random access channel occasion, containing the random access channel occasion. In one or more of these embodiments, computing comprises computing the random access identifier as a function also of an index of the random access channel occasion in the first slot. Alternatively, said computing comprises computing the random access identifier as a function also of an index of a random access channel configuration for transmitting the random access message. Alternatively, said computing comprises computing the random access identifier as a function also of an index of the subcarrier spacing of the random access channel occasion. In one or more of these embodiments, the method further comprises monitoring a downlink control channel for a random access response that is identified by the random access identifier and that is associated with signaling indicating an index of the first slot, from among the multiple slots with the subcarrier spacing of the random access channel occasion, containing the random access channel occasion. In one or more of these embodiments, the method further comprises monitoring a downlink control channel for a random access response that is identified by the random access identifier and that is associated with signaling indicating an index of the random access channel occasion in the first slot. Alternatively, the method further comprises monitoring a downlink control channel for a random access response that is identified by the random access identifier and that is associated with signaling indicating a random access channel configuration of the random access message. Alternatively, the method further comprises monitoring a downlink control channel for a random access response that is identified by the random access identifier and that is associated with signaling indicating an index of the subcarrier spacing of the random access channel occasion.

In some embodiments, the random access identifier is a Random Access Radio Network Temporary Identifier, RA-RNTI.

In some embodiments, the method further comprises monitoring a downlink control channel for a random access response identified by the random access identifier.

In some embodiments, the method further comprises, after transmitting the random access message, receiving, on a downlink control channel, a random access response identified by the random access identifier.

Other embodiments herein include a method performed by a network node configured for use in a wireless communication network. The method comprises receiving a random access message transmitted by a wireless communication device using a random access channel occasion and a random access identifier. The method also comprises, in response to the random access message, transmitting, on a downlink control channel, a random access response identified by the random access identifier. In this case, a subcarrier spacing of the random access channel occasion is different than a subcarrier spacing used to determine the random access identifier.

In some embodiments, a subcarrier spacing used to determine the index is smaller than the subcarrier spacing of the random access channel occasion.

In some embodiments, the first slot, from among multiple slots with the subcarrier spacing used to determine the index, that contains the random access channel occasion spans multiple slots with the subcarrier spacing of the random access channel occasion.

In some embodiments, the subcarrier spacing used to determine the random access identifier is 120 kHz and the subcarrier spacing of the random access channel occasion is higher than 120 kHz.

In some embodiments, the random access identifier is a Random Access Radio Network Temporary Identifier, RA-RNTI.

In some embodiments, the random access identifier is a function of an index of the first slot of the random access channel occasion in a system frame.

In some embodiments, the random access identifier is equal to 1+s_id+14×t_id+14×80×f_id+14×80×8×ul_carrier_id. In this case, s_id is an index of the first Orthogonal Frequency Division Multiplexing, OFDM, symbol of the random access channel occasion, t_id is the index of the first slot of the random access channel occasion in a system frame, wherein t_id is determined using a subcarrier spacing different than the subcarrier spacing of the random access channel occasion, f_id is an index of the random access channel occasion in the frequency domain, and ul_carrier_id is an uplink carrier used for random access preamble transmission.

In some embodiments, the method further comprises transmitting signaling indicating an index of the first slot, from among multiple slots with a subcarrier spacing of the random access channel occasion, containing the random access channel occasion. Alternatively, the method further comprises transmitting signaling indicating an index of the random access channel occasion in the first slot. Alternatively, the method further comprises transmitting signaling indicating a random access channel configuration of the random access message. Alternatively, the method further comprises transmitting signaling indicating an index of the subcarrier.

Other embodiments herein include a wireless communication device configured for use in a wireless communication network. The wireless communication device is configured to compute a random access identifier associated with a random access channel occasion as a function of an index of the first slot of the random access channel occasion in a system frame. In some embodiments, a subcarrier spacing used to determine the index is different than a subcarrier spacing of the random access channel occasion. The wireless communication device is also configured to transmit a random access message using the random access channel occasion and the computed random access identifier.

In some embodiments, the wireless communication device is configured to perform the steps described above for a wireless communication device.

Other embodiments herein include a network node configured for use in a wireless communication network. The network node is configured to receive a random access message transmitted by a wireless communication device using a random access channel occasion and a random access identifier. The network node is also configured to, in response to the random access message, transmit, on a downlink control channel, a random access response identified by the random access identifier. In some embodiments, a subcarrier spacing of the random access channel occasion is different than a subcarrier spacing used to determine the random access identifier.

In some embodiments, the network node is configured to perform the steps described above for a network node.

Other embodiments herein include a computer program comprising instructions which, when executed by at least one processor of a wireless communication device, causes the wireless communication device to perform the steps described above for a wireless communication device. Other embodiments herein include a computer program comprising instructions which, when executed by at least one processor of a network node, causes the network node to perform the steps described above for a network node. In one or more of these embodiments, a carrier containing the computer program is one of an electronic signal, optical signal, radio signal, or computer readable storage medium.

Other embodiments herein include a wireless communication device configured for use in a wireless communication network. The wireless communication device comprises communication circuitry and processing circuitry. The processing circuitry is configured to compute a random access identifier associated with a random access channel occasion as a function of an index of the first slot of the random access channel occasion in a system frame. In this case, a subcarrier spacing used to determine the index is different than a subcarrier spacing of the random access channel occasion. The processing circuitry is also configured to transmit a random access message using the random access channel occasion and the computed random access identifier.

In some embodiments, the processing circuitry is configured to perform the steps described above for a wireless communication device.

Other embodiments herein include a network node configured for use in a wireless communication network. The network node comprises communication circuitry and processing circuitry. The processing circuitry is configured to receive a random access message transmitted by a wireless communication device using a random access channel occasion and a random access identifier. The processing circuitry is also configured to, in response to the random access message, transmit, on a downlink control channel, a random access response identified by the random access identifier. In this case, a subcarrier spacing of the random access channel occasion is different than a subcarrier spacing used to determine the random access identifier.

In some embodiments, the processing circuitry is configured to perform the steps described above for a network node.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network according to some embodiments.

FIG. 2 is a block diagram of a wireless communication network according to other embodiments.

FIG. 3 is a logic flow diagram of a method performed by a wireless communication device according to some embodiments.

FIG. 4 is a logic flow diagram of a method performed by a wireless communication device according to other embodiments.

FIG. 5 is a logic flow diagram of a method performed by a network node according to some embodiments.

FIG. 6 is a logic flow diagram of a method performed by a network node according to other embodiments.

FIG. 7 is a block diagram of a wireless communication device according to other embodiments.

FIG. 8 is a block diagram of a network node according to some embodiments.

FIG. 9 is a call flow diagram of a 4-step random access procedure according to some embodiments.

FIG. 10 is a call flow diagram of a 2-step random access procedure according to some embodiments.

FIG. 11 is a block diagram of a MAC subheader with Backoff Indicator according to some embodiments.

FIG. 12 is a block diagram of a MAC subheader with RAPID according to some embodiments.

FIG. 13 is a block diagram of a MAC PDU consisting of MAC RARs according to some embodiments.

FIG. 14 is a block diagram of a MAC RAR according to some embodiments.

FIG. 15 is a block diagram of a communication system in accordance with some embodiments.

FIG. 16 is a block diagram of a user equipment according to some embodiments.

FIG. 17 is a block diagram of a network node according to some embodiments.

FIG. 18 is a block diagram of a host according to some embodiments.

FIG. 19 is a block diagram of a virtualization environment according to some embodiments.

FIG. 20 is a block diagram of a host communicating via a network node with a UE over a partially wireless connection in accordance with some embodiments.

### DETAILED DESCRIPTION

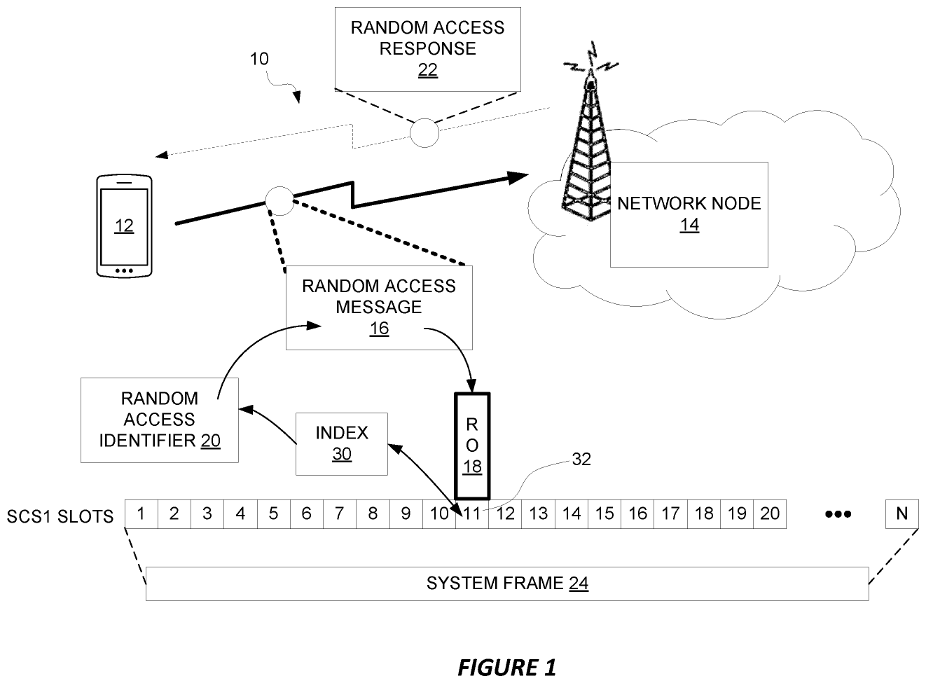

FIG. 1 shows a wireless communication network 10 according to some embodiments. As shown, a wireless communication device 12 (also referred to as a wireless device or a user equipment, UE) is configured to perform random access to the wireless communication network 10. For example, the wireless communication device 12 may perform random access to a cell served by a network node 14, e.g., a radio network node, in the wireless communication network 10.

The wireless communication device 12 in this regard transmits a random access message 16, e.g., MSGA of a two-step random access procedure or MSG1 of a random access procedure. The random access message 16 may for example comprise a random access preamble. The wireless communication device 12 in particular transmits the random access message 16 using a random access channel occasion (RO) 18, e.g., an occasion defined in time for transmission of the random access message 16.

In some embodiments, the wireless communication device 12 computes a random access identifier 20 associated with this RO 18. The wireless communication network 10 may use this random access identifier 20 to send a random access response 22 to the wireless communication device 10. For example, the wireless communication device 12 may monitor a downlink control channel for a random access response 22 identified by the random access identifier 20. In one or more embodiments, for example, the downlink control channel is addressed using the random access identifier 20. After transmitting the random access message 16, then, the wireless communication device 12 may receive, on a downlink control channel, a random access response 22 identified by the random access identifier 20.

In any event, as shown, the wireless communication network 10 structures its transmissions in the time domain in terms of a system frame 24, e.g., having a length of 10 ms. The system frame 24 is in turn divided into multiple slots, e.g., with each slot comprising multiple symbols. The number of slots in the system frame 24 depends on the subcarrier spacing according to which those slots are formed. As shown, for example, with a first subcarrier spacing SCS1, there are N slots in the system frame 24.

In this context, the wireless communication device 12 in some embodiments computes the random access identifier 20 as a function of an index 30 of the first slot 32 of the RO 18 in a system frame 24. As shown in this example, the first slot 32 of the RO 18 in the system frame 24 is slot 11 (with SCS1), so the random access identifier 20 is computed as a function of an index of slot 11.

In some embodiments, the possible values for the index 30 include values greater than 80. This may thereby accommodate for more than 80 slots in the system frame 24 (i.e., N>80), which is the case for a subcarrier spacing higher than 120 kHz. In one embodiment, for instance, the possible values for the index 30 include values greater than or equal to zero and less than 640.

As a concrete example, the random access identifier 20 may be computed as 1+s_id+14×t_id+14×80×f_id+14×80×8×ul_carrier_id, wherein s_id is an index of the first Orthogonal Frequency Division Multiplexing, OFDM, symbol of the RO 18, t_id is the index 30 of the first slot 32 of the RO 18 in a system frame 24, f_id is an index of the RO 18 in the frequency domain, and ul_carrier_id is an uplink carrier used for random access preamble transmission.

As a further example, where the random access identifier 20 is a random access radio network temporary identifier (RA-RNTI), in the formula of RA-RNTI, t_id is the index of the first slot 32 of the RO 18 in a system frame 24, and its value range is updated as 0≤t_id<640 allowing the subcarrier spacing (SCS) up to 960 kHz to be supported.

In other embodiments, a subcarrier spacing used to determine the index 30 is different than (e.g., smaller than) a subcarrier spacing of the RO 18. For example, a subcarrier spacing used to determine the index 30 may be 120 kHz, whereas the subcarrier spacing of the RO 18 is greater than 120 kHz.

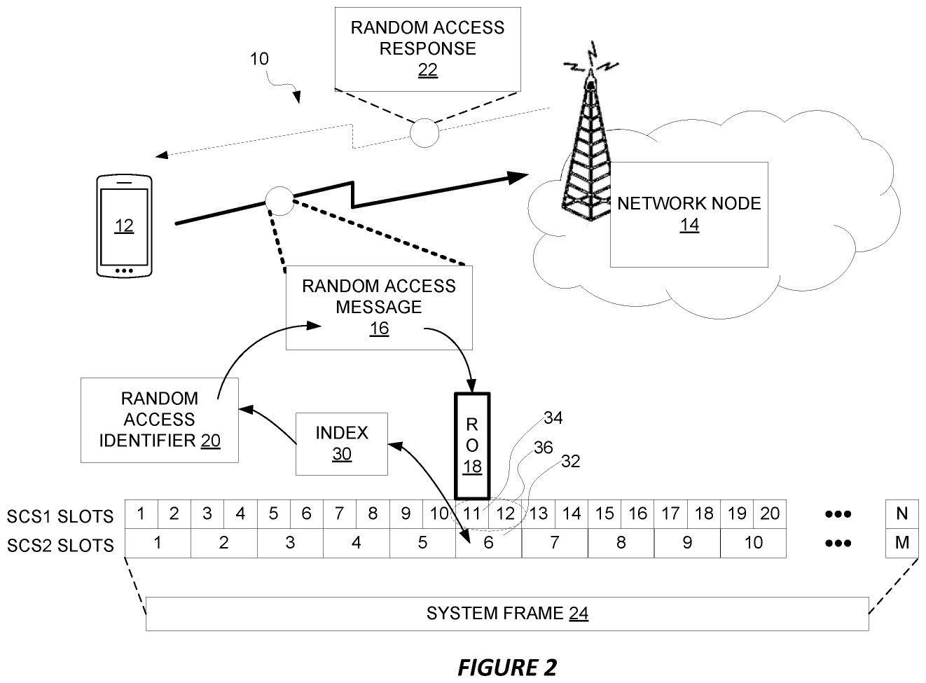

As shown in FIG. 2, for instance, even though the subcarrier spacing of the RO 18 is SCS1, the wireless communication device 12 uses SCS2 to determine the index 30 of the first slot of the RO 18. With SCS2, then, slot 6 is the first slot of the RO 18 in this example, so the wireless communication device 12 computes the random access identifier 18 associated with RO 18 as a function of an index 30 of slot 6 (with SCS2). This is the case even though, with SCS1, slot 11 is the first slot of the RO 18. Therefore, the first slot 32 of the RO 18 according to SCS1 may differ from the first slot 34 of the RO 18 according to SCS2.

Notably, the first slot 32 that contains the RO 18 according to subcarrier spacing SCS1 spans multiple slots 36 with the subcarrier spacing SCS2 of the RO 18. Indeed, as shown, slot 6 according to SCS1 spans both slots 11 and 12 according to SCS2. That is, the first slot 32, from among multiple slots 1 to M with the subcarrier spacing SCS1 used to determine the index 30, that contains the RO 18 spans multiple slots 36 (e.g., slots 11-12) with the subcarrier spacing SCS2 of the RO 18.

In this context, with the index 30 of the first slot 32 of the RO 18 determined using SCS1, some embodiments compute the random access identifier 18 as a function of one or more other parameters that account for which of the multiple slots 36 is the first slot 34 of the RO 18 according to SCS2. For example, some embodiments compute the random access identifier 20 as a function also of an index of the first slot 34, from among the multiple slots 36 with the subcarrier spacing of the RO 18, containing the RO 18. Other embodiments compute the random access identifier 20 as a function also of an index of the RO 18 in the first slot 32. Yet other embodiments compute the random access identifier 20 as a function also of an index of a random access channel configuration for transmitting the random access message 16. Still other embodiments compute the random access identifier 20 as a function also of an index of the subcarrier spacing of the RO 18.

In other embodiments, by contrast, the random access identifier 20 is computed without any parameter that accounts for which of the multiple slots 36 is the first slot 34 of the RO 18 according to SCS2. Instead, the wireless communication network 10 (e.g., network node 14) transmits signaling to the wireless communication device 12 in association with the random access response 22. In one embodiment, the signaling indicates an index of the first slot 34, from among the multiple slots 36 with the subcarrier spacing of the RO 18, containing the RO 18. In other embodiments, the signaling indicates an index of the RO 18 in the first slot 32. In yet other embodiments, the signaling indicates an index of a random access channel configuration for transmitting the random access message 16. In still other embodiments, the signaling indicates an index of the subcarrier spacing of the RO 18.

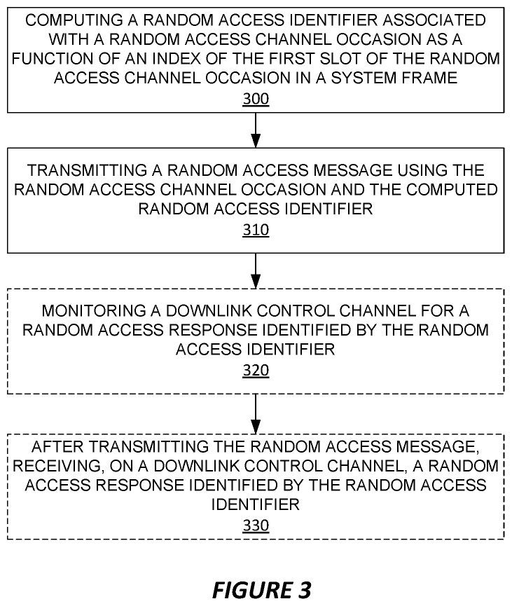

FIG. 3 depicts a corresponding method performed by a wireless communication device 12 configured for use in a wireless communication network 10 in accordance with particular embodiments. The method includes computing a random access identifier 20 associated with a random access channel occasion (RO) 18 as a function of an index 30 of the first slot of the random access channel occasion 18 in a system frame 24 (Block 300). In some embodiments, the possible values for the index 30 include values greater than 80. In other embodiments, a subcarrier spacing used to determine the index 30 is different than a subcarrier spacing of the random access channel occasion 18. Regardless, the method as shown may also comprise transmitting a random access message 16 using the random access channel occasion 18 and the computed random access identifier 20 (Block 310).

In some embodiments, the method further comprises monitoring a downlink control channel for a random access response 22 identified by the random access identifier 20 (Block 320).

Alternatively or additionally, the method may further comprise after transmitting the random access message 16, receiving, on a downlink control channel, a random access response 22 identified by the random access identifier 20 (Block 330).

In some embodiments, the possible values for the index 30 include values greater than 80. In one or more of these embodiments, a subcarrier spacing used to determine the index 30 is greater than 120 kHz. In one or more of these embodiments, the possible values for the index 30 include values greater than or equal to zero and less than 640. In one or more of these embodiments, said computing comprises computing the random access identifier 20 as 1+s_id+14×t_id+4×80×fid+14×80×8×ul_carrierid. In this case, s_id is an index of the first Orthogonal Frequency Division Multiplexing, OFDM, symbol of the random access channel occasion 18, tid is the index 30 of the first slot 32 of the random access channel occasion 18 in a system frame 24, f_id is an index of the random access channel occasion 18 in the frequency domain, and ul_carrier_id is an uplink carrier used for random access preamble transmission.

In some embodiments, the subcarrier spacing used to determine the index 30 is different than the subcarrier spacing of the random access channel occasion 18. In one or more of these embodiments, the subcarrier spacing used to determine the index 30 is smaller than a subcarrier spacing of the random access channel occasion 18. In one or more of these embodiments, a subcarrier spacing used to determine the index 30 is 120 kHz. In one or more of these embodiments, said computing comprises computing the random access identifier 20 as 1+s_id+14×t_id+14×80×f_id+14×80×8×ul_carrier_id. In this case, s_id is an index of the first Orthogonal Frequency Division Multiplexing, OFDM, symbol of the random access channel occasion 18, t_id is the index 30 of the first slot 32 of the random access channel occasion 18 in a system frame 24, f_id is an index of the random access channel occasion 18 in the frequency domain, and ul_carrier_id is an uplink carrier used for random access preamble transmission.

In some embodiments, the subcarrier spacing used to determine the index 30 is smaller than a subcarrier spacing of the random access channel occasion 18. In some embodiments, the first slot 32, from among multiple slots 36 with the subcarrier spacing used to determine the index 30, that contains the random access channel occasion 18 spans multiple slots 36 with the subcarrier spacing of the random access channel occasion 18.

In some embodiments, said computing comprises computing the random access identifier 20 as a function also of an index 30 of the first slot 34, from among the multiple slots 36 with the subcarrier spacing of the random access channel occasion 18, containing the random access channel occasion 18.

In some embodiments, said computing comprises computing the random access identifier 20 as a function also of an index of the random access channel occasion 18 in the first slot 32.

In some embodiments, said computing comprises computing the random access identifier 20 as a function also of an index of a random access channel configuration for transmitting the random access message 16.

In some embodiments, said computing comprises computing the random access identifier 20 as a function also of an index of the subcarrier spacing of the random access channel occasion 18.

In some embodiments, the method further comprises monitoring a downlink control channel for a random access response 22 that is identified by the random access identifier 20 and that is associated with signaling indicating an index 30 of the first slot 34, from among the multiple slots 36 with the subcarrier spacing of the random access channel occasion 18, containing the random access channel occasion 18.

In some embodiments, the method further comprises monitoring a downlink control channel for a random access response 22 that is identified by the random access identifier 20 and that is associated with signaling indicating an index of the random access channel occasion 18 in the first slot 32.

In some embodiments, the method further comprises monitoring a downlink control channel for a random access response 22 that is identified by the random access identifier 20 and that is associated with signaling indicating a random access channel configuration of the random access message 16.

In some embodiments, the method further comprises monitoring a downlink control channel for a random access response 22 that is identified by the random access identifier 20 and that is associated with signaling indicating an index of the subcarrier spacing of the random access channel occasion 18.

In some embodiments, the random access message 16 is MSGA of a two-step random access procedure or MSG1 of a four-step random access procedure.

In some embodiments, the random access message 16 comprises a random access preamble.

In some embodiments, the random access channel occasion 18 is a random access channel in which the wireless communication device 12 transmits a random access preamble.

In some embodiments, the random access identifier 20 is a Random Access Radio Network Temporary Identifier, RA-RNTI.

In some embodiments, said computing comprises computing the random access identifier 20 as a function also of at least an index of the first symbol of the random access channel occasion 18. Additionally or alternatively, said computing comprises computing the random access identifier 20 as a function also of at least an index of the random access channel occasion 18 in the frequency domain. Additionally or alternatively, said computing comprises computing the random access identifier 20 as a function also of at least an uplink carrier used for random access preamble transmission.

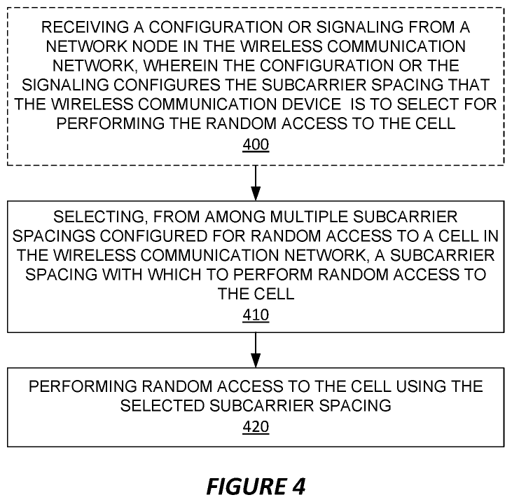

FIG. 4 depicts a method performed by a wireless communication device 12 configured for use in a wireless communication network 10 in accordance with other particular embodiments. The method comprises selecting, from among multiple subcarrier spacings configured for random access to a cell in the wireless communication network, a subcarrier spacing with which to perform random access to the cell (Block 410). The method may further comprise performing random access to the cell using the selected subcarrier spacing (Block 420).

In some embodiments, the method alternatively or additionally comprises receiving a configuration or signaling from a network node in the wireless communication network, wherein the configuration or the signaling configures the subcarrier spacing that the wireless communication device is to select for performing the random access to the cell (Block 400).

In some embodiments, the subcarrier spacing is selected based on a service, application, or traffic type that triggered the random access to the cell.

In some embodiments, the subcarrier spacing is selected based on a priority of a service, application, or traffic type that triggered the random access to the cell. In one or more of these embodiments, said selecting comprises, if the service, application, or traffic type has a first priority, selecting a first subcarrier spacing with which to perform random access to the cell. Said selecting also comprises, if the service, application, or traffic type has a second priority, selecting a second subcarrier spacing with which to perform random access to the cell. In some embodiments, the first priority is lower than the second priority, and the first subcarrier spacing is lower than the second subcarrier spacing. In one or more of these embodiments, said priority is based on at least an application identifier. Additionally or alternatively, said priority is based on at least an access class or access category of the wireless communication device 12.

Additionally or alternatively, said priority is based on at least a logical channel priority of a logic channel containing data for the service, application or traffic type. Additionally or alternatively, said priority is based on at least a logical channel group identifier to which a logic channel containing data for the service, application or traffic type belongs. Additionally or alternatively, said priority is based on at least a radio bearer identifier of a radio bearer used for the service, application, or traffic type. Additionally or alternatively, said priority is based on at least a session or flow identifier of a session or flow used for the service, application, or traffic type.

In some embodiments, the subcarrier spacing is selected based on a quality of service requirement of a service, application, or traffic type that triggered the random access to the cell. In one or more of these embodiments, said selecting comprises, if the service, application, or traffic type has a first quality of service requirement, selecting a first subcarrier spacing with which to perform random access to the cell. Said selecting also comprises, if the service, application, or traffic type has a second quality of service requirement, selecting a second subcarrier spacing with which to perform random access to the cell. In some embodiments, the first quality of service requirement is lower than the second quality of service requirement, and the first subcarrier spacing is lower than the second subcarrier spacing. In one or more of these embodiments, the second quality of service requirement requires lower latency than the first quality of service requirement.

In some embodiments, the subcarrier spacing is selected based on a purpose for which random access to the cell is triggered. In one or more of these embodiments, said selecting comprises, if random access to the cell is triggered for the purpose of initial access from a radio resource control idle state, selecting a first subcarrier spacing with which to perform random access to the cell. Said selecting also comprises, if random access to the cell is triggered for the purpose of handover or beam failure recovery, selecting a second subcarrier spacing with which to perform random access to the cell. In some embodiments, the first subcarrier spacing is lower than the second subcarrier spacing.

In some embodiments, the subcarrier spacing is selected based on a capability of the wireless communication device 12, an access class of the wireless communication device 12, or an access category of the wireless communication device 12.

In some embodiments, the subcarrier spacing is selected based on a volume of data which triggered the random access to the cell.

In some embodiments, the subcarrier spacing is selected based on a signal strength or quality measured for the wireless communication device 12. In one or more of these embodiments, said selecting comprises, if the wireless communication device 12 has a first signal strength or quality, selecting a first subcarrier spacing with which to perform random access to the cell. Said selecting also comprises, if the wireless communication device 12 has a second signal strength or quality, selecting a second subcarrier spacing with which to perform random access to the cell. In some embodiments, the first signal strength or quality is lower than the second signal strength or quality, and the first subcarrier spacing is lower than the second subcarrier spacing.

In some embodiments, the subcarrier spacing is selected based on a location of the wireless communication device 12. In one or more of these embodiments, said selecting comprises, if the wireless communication device 12 has a first location, selecting a first subcarrier spacing with which to perform random access to the cell. Said selecting also comprises, if the wireless communication device 12 has a second location, selecting a second subcarrier spacing with which to perform random access to the cell. In some embodiments, the first location is farther away from a serving radio network node of the wireless communication device 12 than the second location, and the first subcarrier spacing is lower than the second subcarrier spacing.

In some embodiments, the subcarrier spacing is selected based on a remaining battery life of the wireless communication device 12. In one or more of these embodiments, said selecting comprises, if the wireless communication device 12 has a first remaining battery life, selecting a first subcarrier spacing with which to perform random access to the cell. Said selecting also comprises, if the wireless communication device 12 has a second remaining battery life, selecting a second subcarrier spacing with which to perform random access to the cell. In some embodiments, the first remaining battery life is lower than the second remaining battery life, and the first subcarrier spacing is lower than the second subcarrier spacing.

In some embodiments, the subcarrier spacing is selected based on a power class of the wireless communication device 12 and/or a transmit power of the wireless communication device 12. In one or more of these embodiments, said selecting comprises, if the wireless communication device 12 has a first power class or a first transmit power, selecting a first subcarrier spacing with which to perform random access to the cell. Said selecting also comprises, if the wireless communication device 12 has a second power class or a second transmit power, selecting a second subcarrier spacing with which to perform random access to the cell. In some embodiments, the first power class is lower than the second power class and/or the first transmit power is lower than the second transmit power. In some embodiments, the first subcarrier spacing is lower than the second subcarrier spacing.

In some embodiments, said performing comprises performing at least one random access transmission to the cell using the selected subcarrier spacing. In one or more of these embodiments, the method further comprises, after performing at least one random access transmission to the cell using the selected subcarrier spacing, performing at least one other random access transmission to the cell using a different subcarrier spacing. In one or more of these embodiments, the at least one random access transmission includes a transmission of a certain random access message 16, and the at least one other random access transmission includes a re-transmission of the same random access message 16. In one or more of these embodiments, the at least one random access transmission includes a transmission of a certain random access message 16, and the at least one other random access transmission includes a transmission of a different random access message 16 in the same random access procedure.

Other embodiments herein include a method performed by a wireless communication device 12 configured for use in a wireless communication network 10. The method comprises receiving a configuration or signaling from a network node 14 in the wireless communication network 10. In this case, the configuration or the signaling configures a subcarrier spacing that the wireless communication device 12 is to use for performing the random access to the cell. The method also comprises performing random access to the cell using the configured subcarrier spacing.

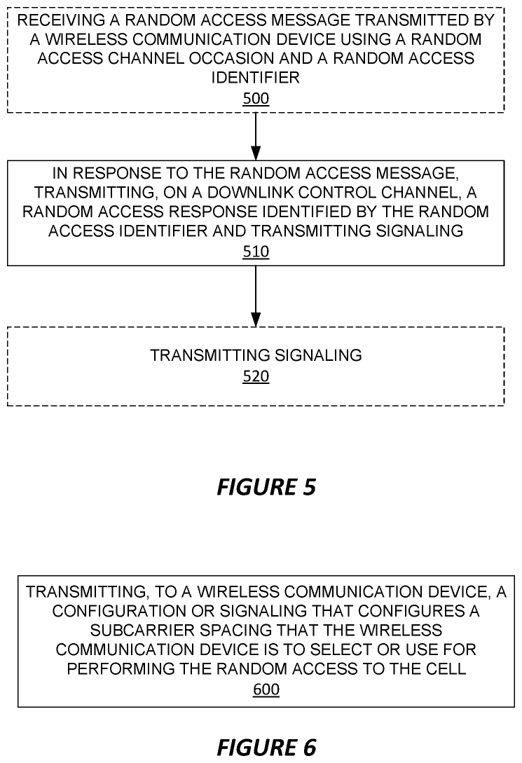

FIG. 5 depicts a method performed by a network node 14 configured for use in a wireless communication network 10 in accordance with other particular embodiments. The method comprises receiving a random access message 16 transmitted by a wireless communication device 12 using a random access channel occasion 18 and a random access identifier 20 (Block 500). The method also comprises, in response to the random access message 16, transmitting, on a downlink control channel, a random access response 22 identified by the random access identifier 20 (Block 510). In some embodiments, a subcarrier spacing of the random access channel occasion 18 is different than a subcarrier spacing used to determine the random access identifier 20.

In some embodiments, the method also comprises, in response to the random access message 16, transmitting signaling (Block 520). In some embodiments the signaling indicates (i) an index of the first slot, from among multiple slots 36 with a subcarrier spacing of the random access channel occasion 18, containing the random access channel occasion 18; (ii) an index of the random access channel occasion 18 in the first slot; (iii) a random access channel configuration of the random access message 16; or (iv) an index of the subcarrier spacing of the random access channel occasion 18.

In some embodiments, the subcarrier spacing of the random access channel occasion 18 is different than a subcarrier spacing used to determine the random access identifier 20. In one or more of these embodiments, the subcarrier spacing of the random access channel occasion 18 is higher than a subcarrier spacing used to determine the random access identifier 20.

In some embodiments, the subcarrier spacing used to determine the random access identifier 20 is 120 kHz and the subcarrier spacing of the random access channel occasion 18 is higher than 120 kHz.

In some embodiments, the random access message 16 is MSGA of a two-step random access procedure or MSG1 of a four-step random access procedure.

In some embodiments, the random access message 16 comprises a random access preamble.

In some embodiments, the random access channel occasion 18 is a random access channel in which the wireless communication device 12 transmits a random access preamble.

In some embodiments, the random access identifier 20 is a Random Access Radio Network Temporary Identifier, RA-RNTI.

In some embodiments, the random access identifier 20 is a function of an index 30 of the first slot 32 of the random access channel occasion 18 in a system frame 24, as determined using a subcarrier spacing different than the subcarrier spacing of the random access channel occasion 18. In one or more of these embodiments, the random access identifier 20 is a function also of at least an index of the first symbol of the random access channel occasion 18. Additionally or alternatively, the random access identifier 20 is a function also of at least an index of the random access channel occasion 18 in the frequency domain. Additionally or alternatively, the random access identifier 20 is a function also of at least an uplink carrier used for random access preamble transmission.

In some embodiments, the random access identifier 20 is equal to 1+s_id+14×t_id+14×80×f_id+14×80×8×ul_carrier_id. In this case, s_id is an index of the first Orthogonal Frequency Division Multiplexing, OFDM, symbol of the random access channel occasion 18, t_id is the index 30 of the first slot 32 of the random access channel occasion 18 in a system frame 24, wherein t_id is determined using a subcarrier spacing different than the subcarrier spacing of the random access channel occasion 18, f_id is an index of the random access channel occasion 18 in the frequency domain, and ul_carrier_id is an uplink carrier used for random access preamble transmission.

In some embodiments, a subcarrier spacing used to determine the index 30 is smaller than the subcarrier spacing of the random access channel occasion 18. In this case, the first slot 32, from among multiple slots with the subcarrier spacing used to determine the index 30, that contains the random access channel occasion 18 spans multiple slots 36 with the subcarrier spacing of the random access channel occasion 18.

In some embodiments, the signaling indicates an index 30 of the first slot 34, from among the multiple slots 36 with the subcarrier spacing of the random access channel occasion 18, containing the random access channel occasion 18.

In some embodiments, the signaling indicates an index of the random access channel occasion 18 in the first slot 32.

In other embodiments, the signaling indicates a random access channel configuration of the random access message 16.

In some embodiments, the signaling indicates an index of the subcarrier spacing of the random access channel occasion 18.

FIG. 6 depicts a method performed by a network node 14 configured for use in a wireless communication network in accordance with other particular embodiments. The method comprises transmitting, to a wireless communication device 12, a configuration or signaling that configures a subcarrier spacing that the wireless communication device 12 is to select or use for performing the random access to the cell (Block 600).

Embodiments herein also include corresponding apparatuses. Embodiments herein for instance include a wireless communication device 12 configured to perform any of the steps of any of the embodiments described above for the wireless communication device 12.

Embodiments also include a wireless communication device 12 comprising processing circuitry and power supply circuitry. The processing circuitry is configured to perform any of the steps of any of the embodiments described above for the wireless communication device 12. The power supply circuitry is configured to supply power to the wireless communication device 12.

Embodiments further include a wireless communication device 12 comprising processing circuitry. The processing circuitry is configured to perform any of the steps of any of the embodiments described above for the wireless communication device 12. In some embodiments, the wireless communication device 12 further comprises communication circuitry.

Embodiments further include a wireless communication device 12 comprising processing circuitry and memory. The memory contains instructions executable by the processing circuitry whereby the wireless communication device 12 is configured to perform any of the steps of any of the embodiments described above for the wireless communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 14 configured to perform any of the steps of any of the embodiments described above for the network node 14.

Embodiments also include a network node 14 comprising processing circuitry and power supply circuitry. The processing circuitry is configured to perform any of the steps of any of the embodiments described above for the network node 14. The power supply circuitry is configured to supply power to the network node 14.

Embodiments further include a network node 14 comprising processing circuitry. The processing circuitry is configured to perform any of the steps of any of the embodiments described above for the network node 14. In some embodiments, the network node 14 further comprises communication circuitry.

Embodiments further include a network node 14 comprising processing circuitry and memory. The memory contains instructions executable by the processing circuitry whereby the network node 14 is configured to perform any of the steps of any of the embodiments described above for the network node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

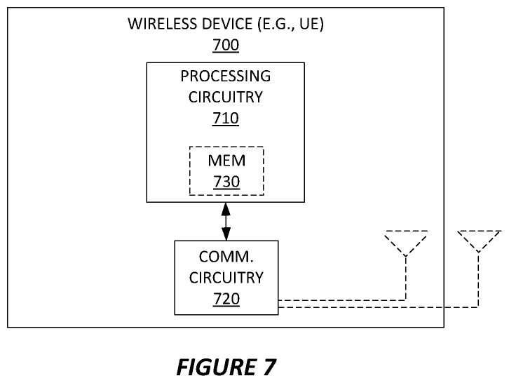

FIG. 7 for example illustrates a wireless device 700 (e.g., wireless communication device 12) as implemented in accordance with one or more embodiments. As shown, the wireless device 700 includes processing circuitry 710 and communication circuitry 720. The communication circuitry 720 (e.g., radio circuitry) is configured to transmit and/or receive information to and/or from one or more other nodes, e.g., via any communication technology. Such communication may occur via one or more antennas that are either internal or external to the wireless device 700. The processing circuitry 710 is configured to perform processing described above, e.g., in FIGS. 3 and/or 4, such as by executing instructions stored in memory 730. The processing circuitry 710 in this regard may implement certain functional means, units, or modules.

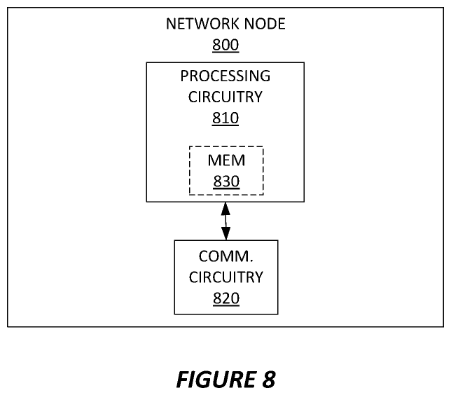

FIG. 8 illustrates a network node 800 (e.g., network node 14) as implemented in accordance with one or more embodiments. As shown, the network node 800 includes processing circuitry 810 and communication circuitry 820. The communication circuitry 820 is configured to transmit and/or receive information to and/or from one or more other nodes, e.g., via any communication technology. The processing circuitry 810 is configured to perform processing described above, e.g., in FIGS. 5 and/or 6, such as by executing instructions stored in memory 830. The processing circuitry 810 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

Some embodiments herein are applicable in a New Radio (NR) system or network. Mobile broadband in this regard will continue to drive demands for higher overall traffic capacity and higher achievable end-user data rates in the wireless access network. Several scenarios in the future will require data rates of up to 10 Gbps in local areas. These demands for very high system capacity and very high end-user date rates can be met by networks with distances between access nodes ranging from a few meters in indoor deployments up to roughly 50 m in outdoor deployments, i.e. with an infra-structure density considerably higher than the densest networks of today. The wide transmission bandwidths needed to provide data rates up to 10 Gbps and above can likely only be obtained from spectrum allocations in the millimeter-wave band. High-gain beamforming, typically realized with array antennas, can be used to mitigate the increased pathloss at higher frequencies. Such networks are referred to as New Radio (NR) systems in the following.

NR supports a diverse set of use cases and a diverse set of deployment scenarios. The latter includes deployment at both low frequencies (100 s of MHz), and very high frequencies (mm waves in the tens of GHz). Two operation frequency ranges are defined in NR Rel-15: FR1 from 410 MHz to 7125 MHz and FR2 from 24.250 GHz to 52.6 GHz.

Some embodiments herein support NR operation above 52.6 GHz and leveraging the FR2 design to the extent possible, e.g., consistent with RP-210862. For example, some embodiments herein support NR operation up to 71 GHz considering both licensed and unlicensed operation.

With regard to physical layer aspects, for example, some embodiments herein support SCSs 120 Khz as well as 480 kHz and 960 kHz, for operation in FR2, for data and control channels and reference signals.

Some embodiments herein also support 120 kHz SCS for SSB and 120 kHz SCS for initial access related signals/channels in an initial BWP, as well as additional SCS (240 kHz, 480 kHz, 960 kHz) for SSB, and additional SCS (480 kHz, 960 kHz) for initial access related signals/channels in an initial BWP.

Some embodiments herein moreover provide support for RO configuration for non-consecutive RACH occasions (RO) in the time domain for operation in shared spectrum.

Some embodiments herein are accordingly applicable for random access in NR. Such random access procedure is triggered by any number of events: (i) Initial access from RRC_IDLE; (ii) Radio Resource Control (RRC) Connection Re-establishment procedure; (iii) downlink (DL) or uplink (UL) data arrival during RRC_CONNECTED when UL synchronisation status is “non-synchronised”; (iv) UL data arrival during RRC_CONNECTED when there are no Physical Uplink Control Channel (PUCCH) resources for Scheduling Request (SR) available; (v) SR failure; (vi) Request by RRC upon synchronous reconfiguration (e.g. handover); (vii) Transition from RRC_INACTIVE; (viii) To establish time alignment for a secondary Timing Advance Group (TAG); (ix) Request for Other System Information (SI); (x) Beam failure recovery; and (xi) Consistent UL Listen-Before-Talk (LBT) failure on SpCell.

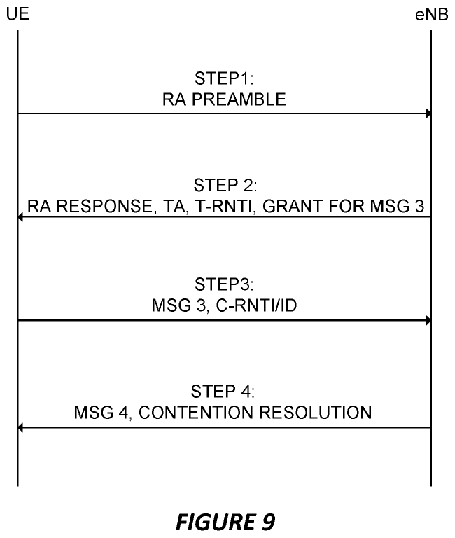

Some embodiments herein are applicable for a four-step random access (RA) procedure. Indeed, the 4-step RA procedure has been used in Long Term Evolution (LTE) and is also proposed as the baseline for NR. FIG. 9 shows the 4-step RA procedure according to some embodiments.

### Step 1: Preamble Transmission

The UE randomly selects a RA preamble (PREAMBLE_INDEX) which is then transmitted by the UE. Some embodiments herein are applicable for a random access message 16 that comprises such a RA preamble in this 4-step RA procedure.

When the eNB detects the preamble, it estimates the Timing alignment (TA) the UE should use in order to obtain UL synchronization at the eNB.

### Step 2: RA Response (RAR)

The eNB sends a RA response (RAR) including the TA, the TC-RNTI (temporary C-RNTI identifier) to be used by the UE, a Random Access Preamble identifier that matches the transmitted PREAMBLE_INDEX and a grant for Msg3. The UE expects the RAR and thus, monitors for a Physical Downlink Control Channel (PDCCH) addressed to the RA-RNTI in order to receive the RAR message from the eNB. The UE monitors the PDCCH in this way until a configured RAR window (ra-ResponseWindow) has expired or until the RAR has been successfully received.

### Step 3: “Msg3” (UE ID or UE-Specific C-RNTI)

In Msg3, the UE transmits its identifier (UE ID) for initial access. Or, if it is already in RRC_CONNECTED or RRC_INACTIVE mode and needs to e.g. resync, the UE transmits its UE-specific RNTI. If the gNB cannot decode Msg3 at the granted UL resources, it may send a Downlink Control Information (DCI) message addressed to the TC-RNTI for retransmission of Msg3. Hybrid Automatic Repeat reQuest (HARQ) retransmission is requested until the UEs restart the random access procedure from step 1 after reaching the maximum number of HARQ retransmissions or until Msg3 can be successfully received by the gNB.

### Step 4: “Msg4” (Contention Resolution)

In Msg4, the eNB responds by acknowledging the UE ID or C-RNTI. The Msg4 gives contention resolution, i.e. only one UE ID or C-RNTI will be sent even if several UEs have used the same preamble (and the same grant for Msg3 transmission) simultaneously.

For Msg4 reception, the UE monitors TC-RNTI (if it transmitted its UE ID in Msg3) or C-RNTI (if it transmitted its C-RNTI in Msg3).

In LTE, the 4-step RA cannot be completed in less than 14 ms/TTI/SF. Here, TTI stands for Transmission Time Interval and SF stands for subframe.

This ordinary four-step RA has been the current standard for legacy systems such as LTE and NR Rel-15. Some embodiments herein by contrast are alternatively or additionally applicable to a two-step RA procedure. In the two-step RA procedure, the UL messages (PRACH+Msg3) are sent simultaneously and similarly the two DL messages (e.g. time advance command in RAR and contention resolution information) are sent as a simultaneous response in the DL. The 2-step RA gives much shorter latency than the ordinary 4-step RA.

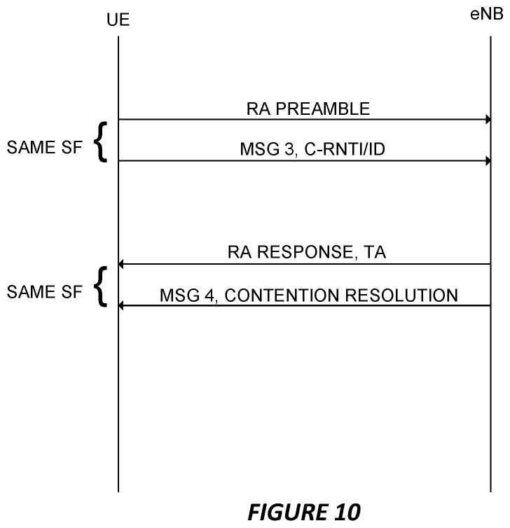

FIG. 10 shows the 2-step RA according to some embodiments. In the 2 step RA the preamble and a message corresponding to Msg3 in the 4-step RA are transmitted in the same or in two subsequent subframes. The Msg 3 is sent on a resource dedicated to the specific preamble. This means that both the preamble and the Msg 3 face contention but contention resolution in this case means that either both preamble and Msg 3 are sent without collision or both collide.

Upon successful reception of the preamble and Msg3, the eNB will respond with a TA (which by assumption should not be needed or just give very minor updates) and a Msg4 for contention resolution.

In the legacy four step procedure, one major purpose of the first two messages is to obtain UL time alignment for the UE. In many situations, e.g. in small cells or for stationary UEs, this may not be needed since either a TA=0 will be sufficient (small cells) or a stored TA value from the last RA could serve also for the current RA (stationary UE). In future radio networks it can be expected that these situations are common, both due to dense deployments of small cells and a great number of e.g. stationary Internet-of-Things (IoT) devices. A possibility to skip the message exchange in cases there is no need to obtain the TA value would lead to reduced RA latency and would be beneficial in several use cases, for example when transmitting infrequent small data packets. On the other hand, the two-step RA will consume more resources since it uses contention-based transmission of the data. This means that the resources that are configured for the data transmission may often be unused.

If both the 4-step and 2-step RA are configured in a cell (and for the UE), the UE will choose its preamble from one specific set if it wants to do a 4-step RA, and from another set if it wants to do a 2-step RA. Hence a preamble partition is done to distinguish between 4-step and 2-step RA. Alternatively, the Physical Random Access Channel (PRACH) configurations are different for the 2-step and 4-step RA procedure, in which case it can be deduced from where the preamble transmission is done if the UE is doing a 2-step or 4-step procedure.

An issue that may occur if the UE TA is bad (e.g. using TA=0 in a large cell or using an old TA even though the UE has moved) is that only the preamble can be detected by the eNB. A transmission with an inaccurate TA value may interfere with transmissions from other UEs in the same cell. Additionally, the preamble signal has higher detection probability than the normal data due to its design pattern. In this case, the network (NV) may reply with an ordinary RAR giving the UE an opportunity to transmit an ordinary Msg3 on a scheduled resource. This is a fallback to 4-step RA.

Whether applied to a 2-step RA or a 4-step RA, some embodiments are applicable for computing an RA-RNTI as an example of the random access identifier 20 herein. The RA-RNTI is associated with the PRACH occasion in which the Random Access Preamble is transmitted. The RA-RNTI may for instance be an RA-RNTI as described in clause 5.1.3 of TS 38.321 v 16.4.0, except modified as described herein.

In some embodiments, the RA-RNTI is computed as:

$$RA - RNTI = 1 + s\_id + 14 \times t\_id + 14 \times 80 \times f\_id + 14 \times 80 \times 8 \times u 1 \_carrier \_id$$

where s_id is the index of the first OFDM symbol of the PRACH occasion (0≤s_id<14), fid is the index of the PRACH occasion in the frequency domain (0≤f_id<8), and ul_carrier_id is the UL carrier used for Random Access Preamble transmission (0 for NUL carrier, and 1 for SUL carrier).

In some embodiments, t_id is the index of the first slot of the PRACH occasion in a system frame (0≤t_id<80), where the subcarrier spacing to determine t_id is 120 kHz.

In other embodiments, t_id is the index of the first slot of the PRACH occasion in a system frame, and its value range is updated as 0≤t_id<640 allowing the subcarrier spacing (SCS) up to 960 kHz to be supported.

In some embodiments, a random access response 22 herein is carried by a Medium Access Control (MAC) Protocol Data Unit (PDU) as described below, e.g., consistent with clause 6.1.5 of TS 38.321 v 16.4.0 except as described otherwise herein.

A MAC PDU consists of one or more MAC subPDUs and optionally padding. Each MAC subPDU consists of one of the following: (i) a MAC subheader with Backoff Indicator only; (ii) a MAC subheader with Random Access Preamble ID (RAPID) only (i.e. acknowledgment for SI request); or (iii) a MAC subheader with RAPID and MAC RAR.

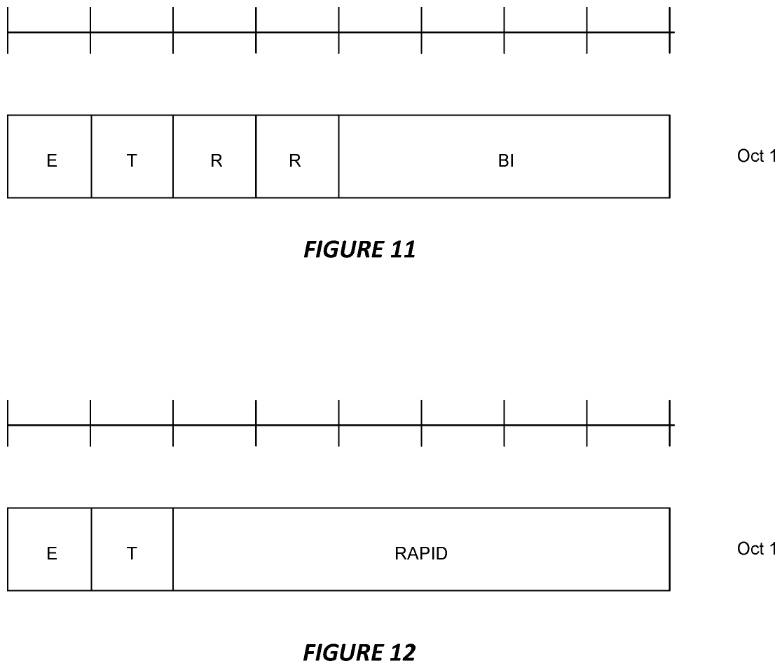

A MAC subheader with Backoff Indicator (BI) consists of five header fields E/T/R/R/BI as described in FIG. 11. A MAC subPDU with Backoff Indicator only is placed at the beginning of the MAC PDU, if included. ‘MAC subPDU(s) with RAPID only’ and ‘MAC subPDU(s) with RAPID and MAC RAR’ can be placed anywhere between MAC subPDU with Backoff Indicator only (if any) and padding (if any).

A MAC subheader with RAPID consists of three header fields E/T/RAPID as described in FIG. 12.

Padding is placed at the end of the MAC PDU if present. Presence and length of padding is implicit based on transport block (TB) size, size of MAC subPDU(s).

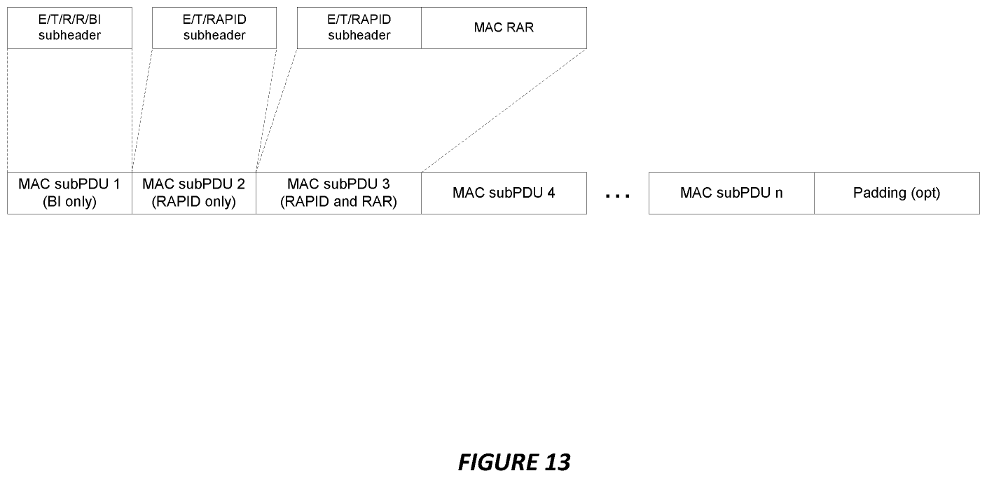

FIG. 13 shows an example of a MAC PDU consisting of MAC RARs, e.g., consistent with TS 38.321 v 16.4.0.

As described in clause 6.2.3 of TS 38.321 V 16.4.0, the MAC RAR is of fixed size, and consists of the following fields: (i) Reserved bit (R) set to “0”; (ii) Timing Advance Command (TAC) field (12 bits) indicating the index value T_{A} used to control the amount of timing adjustment that the MAC entity has to apply in TS 38.213; (iv) UL Grant field (27 bits) indicating the resources to be used on the uplink in TS 38.213; (v) Temporary C-RNTI field (16 bits) indicating the temporary identity that is used by the MAC entity during Random Access.

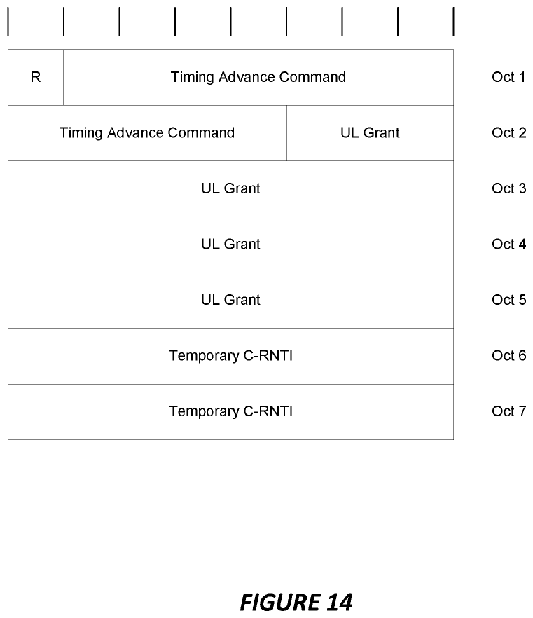

The MAC RAR is octet aligned as shown in FIG. 14.

In this context, e.g., NR operation in bands from 52.6 GHz to 71 GHz, some embodiments support higher SCS including 480 kHz and/or 960 kHz for non-initial access use cases. Some embodiments also support SCS including 480 kHz and/or 960 kHz for initial access use cases.

Some embodiments herein support at least the same density (i.e. number of PRACH slots per reference slot) as for 120 kHz PRACH in FR2. Some embodiments for example provide support for even higher PRACH slot density (number of PRACH slots per reference slot).

Alternatively or additionally, some embodiments support at least the same RO density (i.e. number of RO per reference slot) as for 120 kHz PRACH in FR2. For example, some embodiments provide support for higher RO density.

More particularly, whenever a UE initiates a RACH procedure, the UE transmits a PRACH preamble. After that, the UE can determine a RA-RNTI. If the transmission from the UE can be received by the gNB, the gNB will reply with a Physical Downlink Control Channel (PDCCH) addressed to the RA-RNTI. In this way, the transmission of the PRACH preamble is identified by the gNB. Some embodiments herein enable random access even in the case the SCS values including 480 kHz and 960 kHz are supported.

With the SCS higher than 120 kHz (e.g., 240 kHz, 480 kHz, and 960 kHz), a PRACH slot is much shorter. The maximum number of slots per radio frame is larger than 80. Some embodiments nonetheless make it feasible to distinguish between multiple RACH accesses by different UEs using higher SCS. Some embodiments for example modify the formula to calculate RA-RNTI, so that SCS higher than 120 kHz is supported.

Other embodiments herein account for the possibility to configure a cell with multiple SCS values for PRACH configurations. In this case, some embodiments govern how shall a UE select a PRACH configuration with suitable SCS value.

Generally, then, some embodiments herein provide methods on how RA accesses using a high SCS (e.g., higher than 120 kHz) are identified by UE or gNB. In one option, the formula of RA-RNTI is updated to consider the high SCS values. In another option, after the gNB has identified a RA preamble transmission, the index of the corresponding RA slot or RO is signaled to the UE by gNB. Generally, then, embodiments herein include rules and UE actions on how a UE selects/determines a proper SCS for a RA procedure.

Certain embodiments may provide one or more of the following technical advantage(s).

In some embodiments, a UE is able to apply suitable SCSs for a RA procedure according to its needs. Alternatively or additionally, RA accesses using higher SCS values are identifiable from both UE and gNB perspective. Alternatively or additionally, some embodiments provide more efficient combinations of gNB's control and UE assistance. Alternatively or additionally, different SCSs are efficiently combined for RA accesses in a cell. Alternatively or additionally, quality of service (QoS) requirements associated with RA accesses are better guaranteed.

Some embodiments are applicable to both unlicensed operations and licensed operation.

In the below embodiments, a higher SCS refers to a SCS value (240 kHz, 480 kHz or 960 kHz) which is higher than the SCS of 120 kHz. However, the below embodiments are not limited by any one of these SCS values. In the future, in case even higher SCS value (e.g., 1920 kHz) is adopted, the similar embodiments are equally applicable.

In the first embodiment, in the formula for computing RA-RNTI, where t_id is the index of the first slot of the PRACH occasion in a system frame, the value range for t_id is updated as 0≤t_id<640, allowing the SCS up to 960 kHz to be supported. The first embodiment is an example of Embodiments A1-A24 in GROUP A EMBODIMENTS herein, where the possible values for the index 30 include values greater than 80.

In the second embodiment, the formula for RA-RNTI remains the same as it is even with higher SCS. That is, the value range of t_id is the same as the SCS of 120 kHz. In other words, the UE calculates the RNTI for a RACH access with a higher SCS according to the index of the first 120 kHz reference slot of the PRACH occasion (which is associated with the higher SCS) in the system frame. At least one of the following options may be adopted to identify a RACH access with the higher SCS.

Option 1: for the RACH occasion, the index of the first slot corresponding to the SCS in the system frame is indicated by the gNB to the UE.

If the UE selects a 240 kHz RO to transmit a PRACH preamble, the reference 120 kHz slot contains two 240 kHz slots. The index of the first 240 kHz slot of the selected RO is indicated by the gNB to the UE. The index takes the value of either 0 or 1.

If the UE selects a 480 kHz RO to transmit a PRACH preamble, the reference 120 kHz slot contains four 480 kHz slots. The index of the first 480 Hz slot of the selected RO is indicated by the gNB to the UE. The index takes the integer value in the range between 0 and 3.

If the UE selects a 960 kHz RO to transmit a PRACH preamble, the reference 120 kHz slot contains eight 960 kHz slots. The index of the first 960 Hz slot of the selected RO is indicated by the gNB to the UE. The index takes the integer value in the range between 0 and 7.

Option 2: for the RACH occasion, the index of the RO in the reference 120 kHz slot in the system frame is indicated by the gNB to the UE.

If the UE selects a 240 kHz RO to transmit a PRACH preamble, the reference 120 kHz slot contains two 240 kHz slots. Each 240 kHz slot may contain one or multiple ROs. The index of the RO takes the integer value between 0 and the total number of ROs in the two 240 kHz slots minus 1.

If the UE selects a 480 kHz RO to transmit a PRACH preamble, the reference 120 kHz slot contains four 480 kHz slots. Each 480 kHz slot may contain one or multiple ROs. The index of the RO takes the integer value between 0 and the total number of ROs in the four 480 kHz slots minus 1.

If the UE selects a 960 kHz RO to transmit a PRACH preamble, the reference 120 kHz slot contains eight 960 kHz slots. Each 960 kHz slot may contain one or multiple ROs. The index of the RO takes the integer value between 0 and the total number of ROs in the eight 960 kHz slots minus 1.

Option 3: the index of the corresponding RACH configuration applied by the UE is indicated by the gNB to the UE. The RACH configuration is corresponding to the selected SCS for the RACH access.

Option 4: the index of the corresponding SCS value applied by the UE is indicated by the gNB to the UE.

For any one of the above options, upon reception of the PRACH preamble transmitted by the UE, the gNB may signal the index (the slot or the RO) via at least one of the signaling means.

According to one signaling means, the index is indicated in the DCI carrying the DL assignment of the RAR. The index may occupy R bits, or a new field, or any other existing fields in the DCI.

According to another signaling means, the index is indicated in the MAC subheader of the RAR. The index may occupy R bits, or a new field, or any other existing fields in the MAC subheader of the RAR.

According to yet another signaling means, the index is indicated in the payload of the RAR. The index may occupy R bits, or a new field, or any other existing fields in the RAR payload.

According to still another signaling means, the index is indicated in a MAC CE of the MAC PDU containing the RAR.

According to other signaling means, the index is indicated in another MAC subheader of the MAC PDU containing the RAR. The index may occupy R bits, or a new field, or any other existing fields in the MAC subheader.

The second embodiment is an example of Embodiments A1-A24 in GROUP A EMBODIMENTS herein, where the subcarrier spacing used to determine the index is different than a subcarrier spacing of the random access channel occasion 18.

The third embodiment operates as described in the second embodiment, with the following modifications. In the third embodiment, an additional parameter or input reflecting one of the following is added into the formula of RA-RNTI.
1) the index of the first slot containing the RO in the 120 kHz reference slot (as described in Option 1 of the second embodiment).
2) the index of the RO in the reference 120 kHz slot (as described in Option 2 of the second embodiment).
3) the index of the corresponding RACH configuration applied by the UE (as described in Option 3 of the second embodiment).
4) the index of the corresponding SCS value applied by the UE (as described in Option 4 of the second embodiment).

The third embodiment is also an example of Embodiments A1-A24 in GROUP A EMBODIMENTS herein, where the subcarrier spacing used to determine the index is different than a subcarrier spacing of the random access channel occasion 18.

In the fourth embodiment, for a cell configured with multiple SCS values for RACH configuration, a UE selects a suitable SCS value for a RACH access according to at least one of the following conditions.

A first condition based on which the UE selects a suitable SCS value in some embodiments is the services, applications, and/or traffic types which are being employed by the UE. For example, for high priority services, applications, and/or traffic types, it may be beneficial to apply a high SCS value to reduce the latency. As another example, for low priority services, applications, and/or traffic types, it may be more suitable to apply a low SCS so that the UE may release resources to other services, applications, and/or traffic types with high priority.

As still another example of this first condition, for RRC_IDLE UEs, there are limited ways to define priorities of services (which has the data and triggers the initial access) but for example Application ID or some other global indication of application type can be used. Typically, each app running in Android or IOS has an Android application id (=OS specific application ID identifier) assigned by the app developer. The UE's access class or access category which is typically used for the initial access control, e.g., access barring, can be also applied here to replace Application ID.

As a further example of the first condition, for RRC_CONNECTED or RRC_INACTIVE UEs, the priorities of service which has the data and triggers the initial access should be based on the logical channel (LCH) priority of the LCH containing data. The other identifiers, like the radio bearer ID, logical channel group ID, or session/flow ID (e.g., 5QI, or QFI in NR network, while QCI in LTE network) may be also applied in this table instead of LCH priority. Here, QFI stands for QoS Flow Identifier (QFI) and QCI stands for QoS Class Identifier (QCI).

A second condition based on which the UE selects a suitable SCS value in some embodiments is QoS requirements of the services, applications, and/or traffic types which are being employed by the UE. For example, for services, applications, and/or traffic types with critical QoS requirements such as low latency, it may be beneficial to apply a high SCS to reduce potential latency due to RACH access. As another example, for services, applications, and/or traffic types without critical QoS requirement, it may be more suitable to apply a low SCS so that the UE may release resources to other services, applications, and/or traffic types with critical QoS requirements.

A third condition based on which the UE selects a suitable SCS value in some embodiments is the purpose(s) which trigger the RACH. For example, there may be many different purposes which may trigger the UE to initiate a RA procedure. For some RA purposes which may be delay-sensitive, such as handover or beam failure recovery, the UE may apply a high SCS to reduce the latency due to the RA procedure. For some other RA purposes which may be delay insensitive, such as initial access from RRC_IDLE, the UE may apply a low SCS. It is worth noting that the embodiments are not limited by examples. UE may determine to prioritize any RA purpose and therefore apply a high SCS according to configuration from the gNB or pre-configuration. Alternatively, for which RA purposes that UE shall apply a high SCS or a low SCS is captured in 3GPP specs in a hard coded fashion.

A fourth condition based on which the UE selects a suitable SCS value in some embodiments is UE capabilities, access classes or access categories. For example, for specific UE capabilities, access classes or access categories (e.g., which may require low latency), the UE applies a high SCS. While for other UE capabilities, access classes or access categories (e.g., which may not require low latency), UE applies a low SCS.

A fifth condition based on which the UE selects a suitable SCS value in some embodiments is data volume of the UE. For example, it may be more appropriate for the UE to apply a high SCS if the data volume is above a configured threshold so that the data transmission can be sped up. Otherwise, if there is low data volume, it may be fine for the UE to apply a low SCS.

A sixth condition based on which the UE selects a suitable SCS value in some embodiments is the measured signal strength in terms of RSRP, RSRQ, RSSI, SINR, SIR etc. Here, RSRP stands for Reference Signal Received Power, RSRQ stands for Reference Signal Received Quality, RSSI stands for Reference Signal Strength Indicator, SINR stands for Signal-to-Interference-plus-Noise-Ratio, and SIR stands for Signal-to-Interference Ratio. For example, a high SCS is beneficial for the UE especially when there is low interference, low load or strong radio strength detected. Otherwise, when there is high interference, high load or weak radio strength detected, it is likely that the UE may have bad coverage to the gNB so that it is beneficial for the UE to apply a low SCS to ensure better coverage.

A seventh condition based on which the UE selects a suitable SCS value in some embodiments is the UE's location. For example, in case the UE is close to the gNB, it is suitable to apply a high SCS so that the UE may exploit high data rate and low latency with the high SCS. Otherwise, if the UE is far away from the gNB, the UE may have bad coverage to the gNB so that it is beneficial for the UE to apply a low SCS to ensure better coverage.

An eighth condition based on which the UE selects a suitable SCS value in some embodiments is the UE's battery life. For example, the UE's remaining battery life may affect selection of the SCS for RACH. If the UE has sufficient remaining battery life, the UE may choose a high SCS. While if the UE has low remaining battery life, the UE may apply a low SCS.

A ninth condition based on which the UE selects a suitable SCS value in some embodiments is the UE's power class or recent used transmission power. For example, in case the UE's power class is high or the recent used transmission power is high, the UE may choose a high SCS. Otherwise, the UE applies a low SCS.

In the fifth embodiment, for the same RA access procedure, the UE may change the SCS associated with the RA procedure.

In an example, the UE has transmitted a first RA message (e.g., Msg1 in case of 4-step RA procedure or MsgA in case of 2-step RA procedure) using a given SCS for one or multiple attempts. However, the UE has not received any response message from the gNB. The UE may change to a different SCS for the subsequent transmissions of the first RA message.

In another example, the UE has transmitted a first RA message using a given SCS. The gNB has replied a response message to the UE. However, the UE or the gNB may apply different SCS values for any subsequent RA messages (e.g., Msg2 in case of 4-step RA procedure or MsgB in case of 2-step RA procedure, Msg3, Msg4, Msg5 etc) in the same RA procedure.

In the sixth embodiment, for any one of the above embodiments, the UE may select SCS for a RA procedure according to configuration or signaling from the gNB, or pre-configuration captured in 3GPP specs. Alternatively, how the UE shall select SCS for a RA procedure is captured in 3GPP specs in a hard-coded fashion.

The fourth, fifth, and sixth embodiment is an example of Embodiments AA1-AA25 in GROUP A EMBODIMENTS herein.

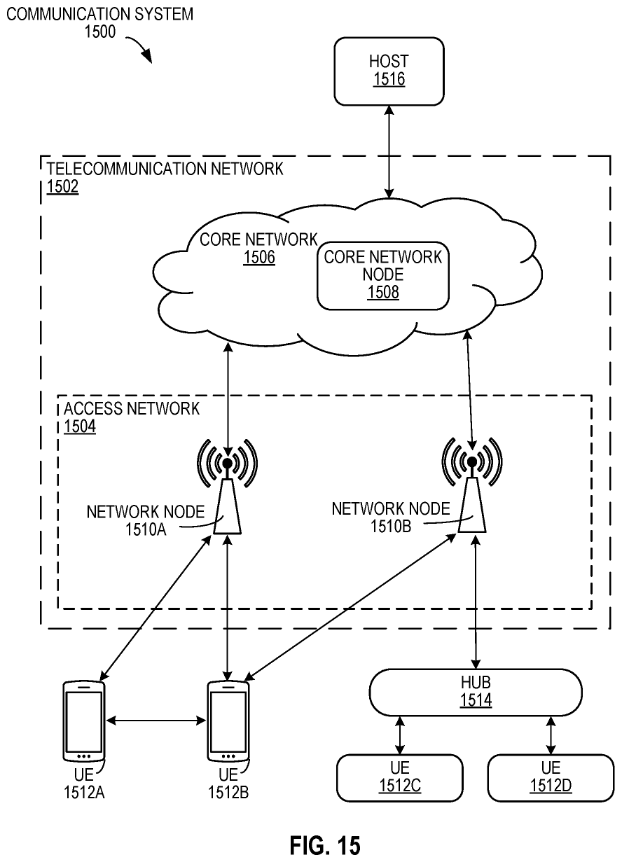

FIG. 15 shows an example of a communication system 1500 in accordance with some embodiments.

In the example, the communication system 1500 includes a telecommunication network 1502 that includes an access network 1504, such as a radio access network (RAN), and a core network 1506, which includes one or more core network nodes 1508. The access network 1504 includes one or more access network nodes, such as network nodes 1510a and 1510b (one or more of which may be generally referred to as network nodes 1510), or any other similar 3^{rd} Generation Partnership Project (3GPP) access node or non-3GPP access point. The network nodes 1510 facilitate direct or indirect connection of user equipment (UE), such as by connecting UEs 1512a, 1512b, 1512c, and 1512d (one or more of which may be generally referred to as UEs 1512) to the core network 1506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1500 may include any number of wired or wireless networks, network nodes, UEs, and/or any other components or systems that may facilitate or participate in the communication of data and/or signals whether via wired or wireless connections. The communication system 1500 may include and/or interface with any type of communication, telecommunication, data, cellular, radio network, and/or other similar type of system.

The UEs 1512 may be any of a wide variety of communication devices, including wireless devices arranged, configured, and/or operable to communicate wirelessly with the network nodes 1510 and other communication devices. Similarly, the network nodes 1510 are arranged, capable, configured, and/or operable to communicate directly or indirectly with the UEs 1512 and/or with other network nodes or equipment in the telecommunication network 1502 to enable and/or provide network access, such as wireless network access, and/or to perform other functions, such as administration in the telecommunication network 1502.

In the depicted example, the core network 1506 connects the network nodes 1510 to one or more hosts, such as host 1516. These connections may be direct or indirect via one or more intermediary networks or devices. In other examples, network nodes may be directly coupled to hosts. The core network 1506 includes one more core network nodes (e.g., core network node 1508) that are structured with hardware and software components. Features of these components may be substantially similar to those described with respect to the UEs, network nodes, and/or hosts, such that the descriptions thereof are generally applicable to the corresponding components of the core network node 1508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1516 may be under the ownership or control of a service provider other than an operator or provider of the access network 1504 and/or the telecommunication network 1502, and may be operated by the service provider or on behalf of the service provider. The host 1516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1500 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1502 is a cellular network that implements 3GPP standardized features. Accordingly, the telecommunications network 1502 may support network slicing to provide different logical networks to different devices that are connected to the telecommunication network 1502. For example, the telecommunications network 1502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1512 are configured to transmit and/or receive information without direct human interaction. For instance, a UE may be designed to transmit information to the access network 1504 on a predetermined schedule, when triggered by an internal or external event, or in response to requests from the access network 1504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1514 communicates with the access network 1504 to facilitate indirect communication between one or more UEs (e.g., UE 1512c and/or 1512d) and network nodes (e.g., network node 1510b). In some examples, the hub 1514 may be a controller, router, content source and analytics, or any of the other communication devices described herein regarding UEs. For example, the hub 1514 may be a broadband router enabling access to the core network 1506 for the UEs. As another example, the hub 1514 may be a controller that sends commands or instructions to one or more actuators in the UEs. Commands or instructions may be received from the UEs, network nodes 1510, or by executable code, script, process, or other instructions in the hub 1514. As another example, the hub 1514 may be a data collector that acts as temporary storage for UE data and, in some embodiments, may perform analysis or other processing of the data. As another example, the hub 1514 may be a content source. For example, for a UE that is a VR headset, display, loudspeaker or other media delivery device, the hub 1514 may retrieve VR assets, video, audio, or other media or data related to sensory information via a network node, which the hub 1514 then provides to the UE either directly, after performing local processing, and/or after adding additional local content. In still another example, the hub 1514 acts as a proxy server or orchestrator for the UEs, in particular in if one or more of the UEs are low energy IoT devices.

The hub 1514 may have a constant/persistent or intermittent connection to the network node 1510b. The hub 1514 may also allow for a different communication scheme and/or schedule between the hub 1514 and UEs (e.g., UE 1512c and/or 1512d), and between the hub 1514 and the core network 1506. In other examples, the hub 1514 is connected to the core network 1506 and/or one or more UEs via a wired connection. Moreover, the hub 1514 may be configured to connect to an M2M service provider over the access network 1504 and/or to another UE over a direct connection. In some scenarios, UEs may establish a wireless connection with the network nodes 1510 while still connected via the hub 1514 via a wired or wireless connection. In some embodiments, the hub 1514 may be a dedicated hub—that is, a hub whose primary function is to route communications to/from the UEs from/to the network node 1510b. In other embodiments, the hub 1514 may be a non-dedicated hub—that is, a device which is capable of operating to route communications between the UEs and network node 1510b, but which is additionally capable of operating as a communication start and/or end point for certain data channels.

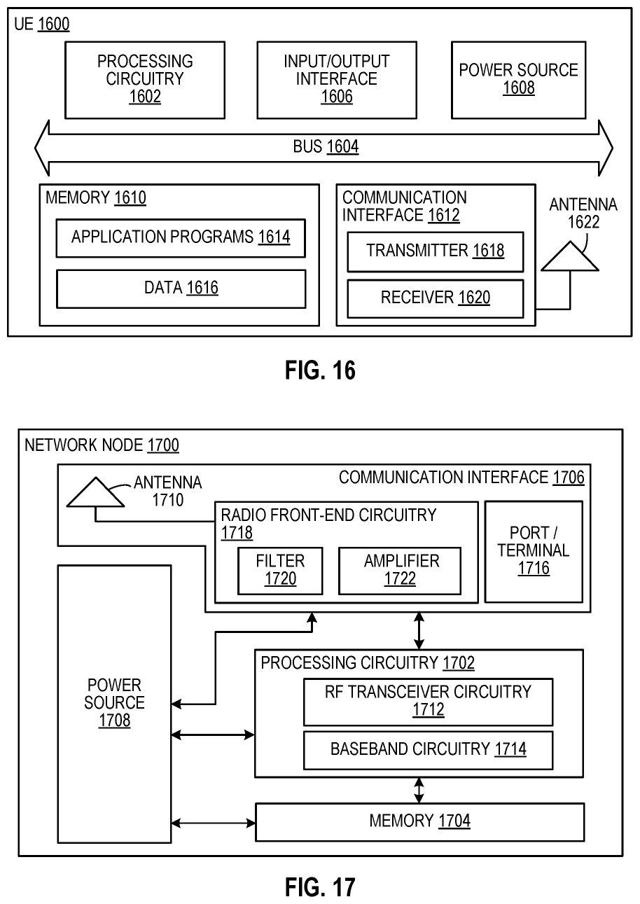

FIG. 16 shows a UE 1600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1600 includes processing circuitry 1602 that is operatively coupled via a bus 1604 to an input/output interface 1606, a power source 1608, a memory 1610, a communication interface 1612, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 1602 is configured to process instructions and data and may be configured to implement any sequential state machine operative to execute instructions stored as machine-readable computer programs in the memory 1610. The processing circuitry 1602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1602 may include multiple central processing units (CPUs).

In the example, the input/output interface 1606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1608 is structured as a battery or battery pack. Other types of power sources, such as an external power source (e.g., an electricity outlet), photovoltaic device, or power cell, may be used. The power source 1608 may further include power circuitry for delivering power from the power source 1608 itself, and/or an external power source, to the various parts of the UE 1600 via input circuitry or an interface such as an electrical power cable. Delivering power may be, for example, for charging of the power source 1608. Power circuitry may perform any formatting, converting, or other modification to the power from the power source 1608 to make the power suitable for the respective components of the UE 1600 to which power is supplied.

The memory 1610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1610 includes one or more application programs 1614, such as an operating system, web browser application, a widget, gadget engine, or other application, and corresponding data 1616. The memory 1610 may store, for use by the UE 1600, any of a variety of various operating systems or combinations of operating systems.

The memory 1610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1610 may allow the UE 1600 to access instructions, application programs and the like, stored on transitory or non-transitory memory media, to off-load data, or to upload data. An article of manufacture, such as one utilizing a communication system may be tangibly embodied as or in the memory 1610, which may be or comprise a device-readable storage medium.

The processing circuitry 1602 may be configured to communicate with an access network or other network using the communication interface 1612. The communication interface 1612 may comprise one or more communication subsystems and may include or be communicatively coupled to an antenna 1622. The communication interface 1612 may include one or more transceivers used to communicate, such as by communicating with one or more remote transceivers of another device capable of wireless communication (e.g., another UE or a network node in an access network). Each transceiver may include a transmitter 1618 and/or a receiver 1620 appropriate to provide network communications (e.g., optical, electrical, frequency allocations, and so forth). Moreover, the transmitter 1618 and receiver 1620 may be coupled to one or more antennas (e.g., antenna 1622) and may share circuit components, software or firmware, or alternatively be implemented separately.

In the illustrated embodiment, communication functions of the communication interface 1612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1600 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 17 shows a network node 1700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1700 includes a processing circuitry 1702, a memory 1704, a communication interface 1706, and a power source 1708. The network node 1700 may be composed of multiple physically separate components (e.g., a NodeB component and a RNC component, or a BTS component and a BSC component, etc.), which may each have their own respective components. In certain scenarios in which the network node 1700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1700 may be configured to support multiple radio access technologies (RATs). In such embodiments, some components may be duplicated (e.g., separate memory 1704 for different RATs) and some components may be reused (e.g., a same antenna 1710 may be shared by different RATs). The network node 1700 may also include multiple sets of the various illustrated components for different wireless technologies integrated into network node 1700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1700.

The processing circuitry 1702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1700 components, such as the memory 1704, to provide network node 1700 functionality.

In some embodiments, the processing circuitry 1702 includes a system on a chip (SOC). In some embodiments, the processing circuitry 1702 includes one or more of radio frequency (RF) transceiver circuitry 1712 and baseband processing circuitry 1714. In some embodiments, the radio frequency (RF) transceiver circuitry 1712 and the baseband processing circuitry 1714 may be on separate chips (or sets of chips), boards, or units, such as radio units and digital units. In alternative embodiments, part or all of RF transceiver circuitry 1712 and baseband processing circuitry 1714 may be on the same chip or set of chips, boards, or units.

The memory 1704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1702. The memory 1704 may store any suitable instructions, data, or information, including a computer program, software, an application including one or more of logic, rules, code, tables, and/or other instructions capable of being executed by the processing circuitry 1702 and utilized by the network node 1700. The memory 1704 may be used to store any calculations made by the processing circuitry 1702 and/or any data received via the communication interface 1706. In some embodiments, the processing circuitry 1702 and memory 1704 is integrated.

The communication interface 1706 is used in wired or wireless communication of signaling and/or data between a network node, access network, and/or UE. As illustrated, the communication interface 1706 comprises port(s)/terminal(s) 1716 to send and receive data, for example to and from a network over a wired connection. The communication interface 1706 also includes radio front-end circuitry 1718 that may be coupled to, or in certain embodiments a part of, the antenna 1710. Radio front-end circuitry 1718 comprises filters 1720 and amplifiers 1722. The radio front-end circuitry 1718 may be connected to an antenna 1710 and processing circuitry 1702. The radio front-end circuitry may be configured to condition signals communicated between antenna 1710 and processing circuitry 1702. The radio front-end circuitry 1718 may receive digital data that is to be sent out to other network nodes or UEs via a wireless connection. The radio front-end circuitry 1718 may convert the digital data into a radio signal having the appropriate channel and bandwidth parameters using a combination of filters 1720 and/or amplifiers 1722. The radio signal may then be transmitted via the antenna 1710. Similarly, when receiving data, the antenna 1710 may collect radio signals which are then converted into digital data by the radio front-end circuitry 1718. The digital data may be passed to the processing circuitry 1702. In other embodiments, the communication interface may comprise different components and/or different combinations of components.

In certain alternative embodiments, the network node 1700 does not include separate radio front-end circuitry 1718, instead, the processing circuitry 1702 includes radio front-end circuitry and is connected to the antenna 1710. Similarly, in some embodiments, all or some of the RF transceiver circuitry 1712 is part of the communication interface 1706. In still other embodiments, the communication interface 1706 includes one or more ports or terminals 1716, the radio front-end circuitry 1718, and the RF transceiver circuitry 1712, as part of a radio unit (not shown), and the communication interface 1706 communicates with the baseband processing circuitry 1714, which is part of a digital unit (not shown).

The antenna 1710 may include one or more antennas, or antenna arrays, configured to send and/or receive wireless signals. The antenna 1710 may be coupled to the radio front-end circuitry 1718 and may be any type of antenna capable of transmitting and receiving data and/or signals wirelessly. In certain embodiments, the antenna 1710 is separate from the network node 1700 and connectable to the network node 1700 through an interface or port.

The antenna 1710, communication interface 1706, and/or the processing circuitry 1702 may be configured to perform any receiving operations and/or certain obtaining operations described herein as being performed by the network node. Any information, data and/or signals may be received from a UE, another network node and/or any other network equipment. Similarly, the antenna 1710, the communication interface 1706, and/or the processing circuitry 1702 may be configured to perform any transmitting operations described herein as being performed by the network node. Any information, data and/or signals may be transmitted to a UE, another network node and/or any other network equipment.

The power source 1708 provides power to the various components of network node 1700 in a form suitable for the respective components (e.g., at a voltage and current level needed for each respective component). The power source 1708 may further comprise, or be coupled to, power management circuitry to supply the components of the network node 1700 with power for performing the functionality described herein. For example, the network node 1700 may be connectable to an external power source (e.g., the power grid, an electricity outlet) via an input circuitry or interface such as an electrical cable, whereby the external power source supplies power to power circuitry of the power source 1708. As a further example, the power source 1708 may comprise a source of power in the form of a battery or battery pack which is connected to, or integrated in, power circuitry. The battery may provide backup power should the external power source fail.

Embodiments of the network node 1700 may include additional components beyond those shown in FIG. 17 for providing certain aspects of the network node's functionality, including any of the functionality described herein and/or any functionality necessary to support the subject matter described herein. For example, the network node 1700 may include user interface equipment to allow input of information into the network node 1700 and to allow output of information from the network node 1700. This may allow a user to perform diagnostic, maintenance, repair, and other administrative functions for the network node 1700.

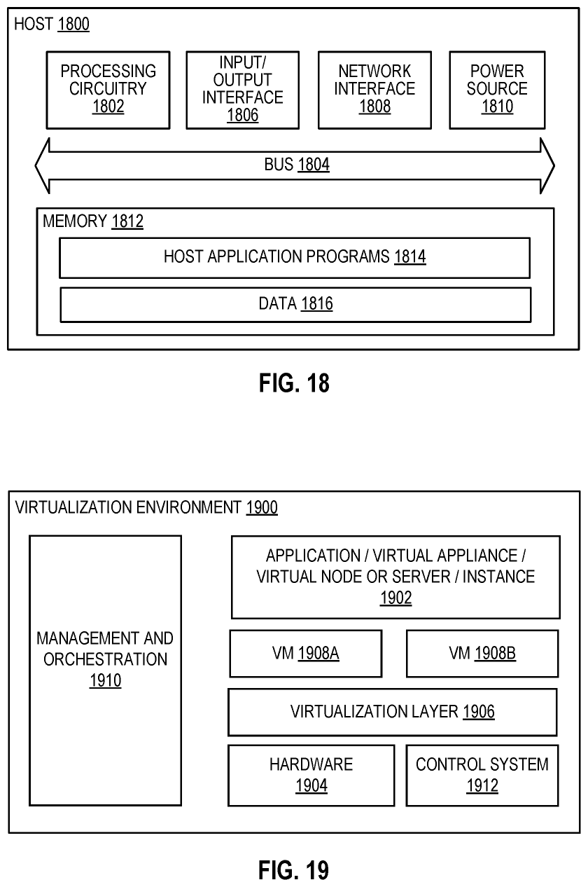

FIG. 18 is a block diagram of a host 1800, which may be an embodiment of the host 1516 of FIG. 15, in accordance with various aspects described herein. As used herein, the host 1800 may be or comprise various combinations hardware and/or software, including a standalone server, a blade server, a cloud-implemented server, a distributed server, a virtual machine, container, or processing resources in a server farm. The host 1800 may provide one or more services to one or more UEs.

The host 1800 includes processing circuitry 1802 that is operatively coupled via a bus 1804 to an input/output interface 1806, a network interface 1808, a power source 1810, and a memory 1812. Other components may be included in other embodiments. Features of these components may be substantially similar to those described with respect to the devices of previous figures, such as FIGS. 16 and 17, such that the descriptions thereof are generally applicable to the corresponding components of host 1800.

The memory 1812 may include one or more computer programs including one or more host application programs 1814 and data 1816, which may include user data, e.g., data generated by a UE for the host 1800 or data generated by the host 1800 for a UE. Embodiments of the host 1800 may utilize only a subset or all of the components shown. The host application programs 1814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1814 may also provide for user authentication and licensing checks and may periodically report health, routes, and content availability to a central node, such as a device in or on the edge of a core network. Accordingly, the host 1800 may select and/or indicate a different host for over-the-top services for a UE. The host application programs 1814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 19 is a block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1906 (also referred to as hypervisors or virtual machine monitors (VMMs)), provide VMs 1908a and 1908b (one or more of which may be generally referred to as VMs 1908), and/or perform any of the functions, features and/or benefits described in relation with some embodiments described herein. The virtualization layer 1906 may present a virtual operating platform that appears like networking hardware to the VMs 1908.

The VMs 1908 comprise virtual processing, virtual memory, virtual networking or interface and virtual storage, and may be run by a corresponding virtualization layer 1906. Different embodiments of the instance of a virtual appliance 1902 may be implemented on one or more of VMs 1908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1908 may be a software implementation of a physical machine that runs programs as if they were executing on a physical, non-virtualized machine. Each of the VMs 1908, and that part of hardware 1904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1908 on top of the hardware 1904 and corresponds to the application 1902.

Hardware 1904 may be implemented in a standalone network node with generic or specific components. Hardware 1904 may implement some functions via virtualization. Alternatively, hardware 1904 may be part of a larger cluster of hardware (e.g. such as in a data center or CPE) where many hardware nodes work together and are managed via management and orchestration 1910, which, among others, oversees lifecycle management of applications 1902. In some embodiments, hardware 1904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1912 which may alternatively be used for communication between hardware nodes and radio units.

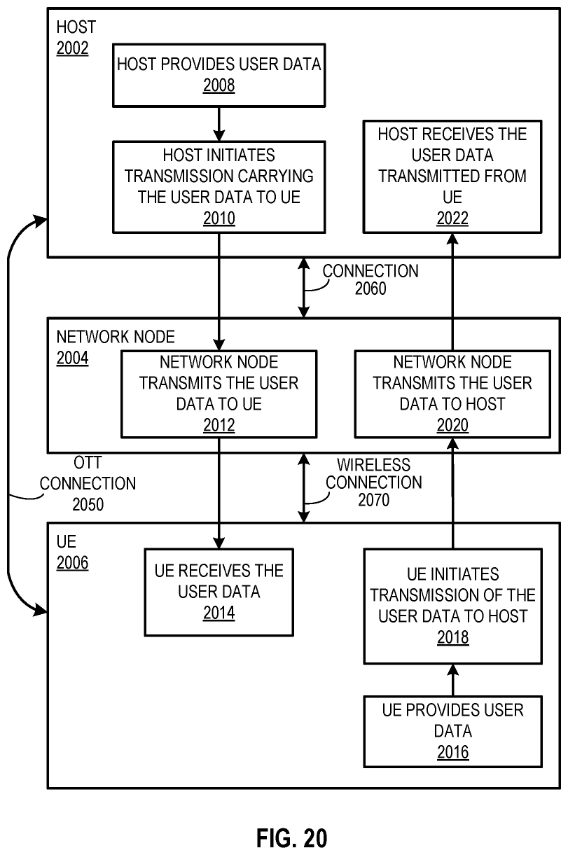

FIG. 20 shows a communication diagram of a host 2002 communicating via a network node 2004 with a UE 2006 over a partially wireless connection in accordance with some embodiments. Example implementations, in accordance with various embodiments, of the UE (such as a UE 1512a of FIG. 15 and/or UE 1600 of FIG. 16), network node (such as network node 1510a of FIG. 15 and/or network node 1700 of FIG. 17), and host (such as host 1516 of FIG. 15 and/or host 1800 of FIG. 18) discussed in the preceding paragraphs will now be described with reference to FIG. 20.

Like host 1800, embodiments of host 2002 include hardware, such as a communication interface, processing circuitry, and memory. The host 2002 also includes software, which is stored in or accessible by the host 2002 and executable by the processing circuitry. The software includes a host application that may be operable to provide a service to a remote user, such as the UE 2006 connecting via an over-the-top (OTT) connection 2050 extending between the UE 2006 and host 2002. In providing the service to the remote user, a host application may provide user data which is transmitted using the OTT connection 2050.

The network node 2004 includes hardware enabling it to communicate with the host 2002 and UE 2006. The connection 2060 may be direct or pass through a core network (like core network 1506 of FIG. 15) and/or one or more other intermediate networks, such as one or more public, private, or hosted networks. For example, an intermediate network may be a backbone network or the Internet.

The UE 2006 includes hardware and software, which is stored in or accessible by UE 2006 and executable by the UE's processing circuitry. The software includes a client application, such as a web browser or operator-specific “app” that may be operable to provide a service to a human or non-human user via UE 2006 with the support of the host 2002. In the host 2002, an executing host application may communicate with the executing client application via the OTT connection 2050 terminating at the UE 2006 and host 2002. In providing the service to the user, the UE's client application may receive request data from the host's host application and provide user data in response to the request data. The OTT connection 2050 may transfer both the request data and the user data. The UE's client application may interact with the user to generate the user data that it provides to the host application through the OTT connection 2050.

The OTT connection 2050 may extend via a connection 2060 between the host 2002 and the network node 2004 and via a wireless connection 2070 between the network node 2004 and the UE 2006 to provide the connection between the host 2002 and the UE 2006. The connection 2060 and wireless connection 2070, over which the OTT connection 2050 may be provided, have been drawn abstractly to illustrate the communication between the host 2002 and the UE 2006 via the network node 2004, without explicit reference to any intermediary devices and the precise routing of messages via these devices.

As an example of transmitting data via the OTT connection 2050, in step 2008, the host 2002 provides user data, which may be performed by executing a host application. In some embodiments, the user data is associated with a particular human user interacting with the UE 2006. In other embodiments, the user data is associated with a UE 2006 that shares data with the host 2002 without explicit human interaction. In step 2010, the host 2002 initiates a transmission carrying the user data towards the UE 2006. The host 2002 may initiate the transmission responsive to a request transmitted by the UE 2006. The request may be caused by human interaction with the UE 2006 or by operation of the client application executing on the UE 2006. The transmission may pass via the network node 2004, in accordance with the teachings of the embodiments described throughout this disclosure. Accordingly, in step 2012, the network node 2004 transmits to the UE 2006 the user data that was carried in the transmission that the host 2002 initiated, in accordance with the teachings of the embodiments described throughout this disclosure. In step 2014, the UE 2006 receives the user data carried in the transmission, which may be performed by a client application executed on the UE 2006 associated with the host application executed by the host 2002.

In some examples, the UE 2006 executes a client application which provides user data to the host 2002. The user data may be provided in reaction or response to the data received from the host 2002. Accordingly, in step 2016, the UE 2006 may provide user data, which may be performed by executing the client application. In providing the user data, the client application may further consider user input received from the user via an input/output interface of the UE 2006. Regardless of the specific manner in which the user data was provided, the UE 2006 initiates, in step 2018, transmission of the user data towards the host 2002 via the network node 2004. In step 2020, in accordance with the teachings of the embodiments described throughout this disclosure, the network node 2004 receives user data from the UE 2006 and initiates transmission of the received user data towards the host 2002. In step 2022, the host 2002 receives the user data carried in the transmission initiated by the UE 2006.

One or more of the various embodiments improve the performance of OTT services provided to the UE 2006 using the OTT connection 2050, in which the wireless connection 2070 forms the last segment.

In an example scenario, factory status information may be collected and analyzed by the host 2002. As another example, the host 2002 may process audio and video data which may have been retrieved from a UE for use in creating maps. As another example, the host 2002 may collect and analyze real-time data to assist in controlling vehicle congestion (e.g., controlling traffic lights). As another example, the host 2002 may store surveillance video uploaded by a UE. As another example, the host 2002 may store or control access to media content such as video, audio, VR or AR which it can broadcast, multicast or unicast to UEs. As other examples, the host 2002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2050 between the host 2002 and UE 2006, in response to variations in the measurement results. The measurement procedure and/or the network functionality for reconfiguring the OTT connection may be implemented in software and hardware of the host 2002 and/or UE 2006. In some embodiments, sensors (not shown) may be deployed in or in association with other devices through which the OTT connection 2050 passes; the sensors may participate in the measurement procedure by supplying values of the monitored quantities exemplified above, or supplying values of other physical quantities from which software may compute or estimate the monitored quantities. The reconfiguring of the OTT connection 2050 may include message format, retransmission settings, preferred routing etc.; the reconfiguring need not directly alter the operation of the network node 2004. Such procedures and functionalities may be known and practiced in the art. In certain embodiments, measurements may involve proprietary UE signaling that facilitates measurements of throughput, propagation times, latency and the like, by the host 2002. The measurements may be implemented in that software causes messages to be transmitted, in particular empty or ‘dummy’ messages, using the OTT connection 2050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a wireless communication device configured for use in a wireless communication network, the method comprising:
computing a random access identifier associated with a random access channel occasion as a function of an index of the first slot of the random access channel occasion in a system frame, wherein either
   the possible values for the index include values greater than 80; or
   a subcarrier spacing used to determine the index is different than a subcarrier spacing of the random access channel occasion;
transmitting a random access message using the random access channel occasion and the computed random access identifier.

A2. The method of embodiment A1, wherein the possible values for the index include values greater than 80.

A3. The method of embodiment A2, wherein a subcarrier spacing used to determine the index is greater than 120 kHz.

A4. The method of any of embodiments A2-A3, wherein the possible values for the index include values greater than or equal to zero and less than 640.

A5. The method of any of embodiments A2-A4, wherein said computing comprises computing the random access identifier as 1+s_id+14×t_id+14×80×f_id+14×80×8×ul_carrier_id, wherein s_id is an index of the first Orthogonal Frequency Division Multiplexing, OFDM, symbol of the random access channel occasion, t_id is the index of the first slot of the random access channel occasion in a system frame, f_id is an index of the random access channel occasion in the frequency domain, and ul_carrier_id is an uplink carrier used for random access preamble transmission.

A6. The method of embodiment A1, wherein the subcarrier spacing used to determine the index is different than the subcarrier spacing of the random access channel occasion.

A7. The method of embodiment A6, wherein the subcarrier spacing used to determine the index is smaller than a subcarrier spacing of the random access channel occasion.

A8. The method of any of embodiments A6-A7, wherein a subcarrier spacing used to determine the index is 120 kHz.

A9. The method of any of embodiments A6-A, wherein said computing comprises computing the random access identifier as 1+s_id+14×t_id+14×80×f_id+14×80×8×ul_carrier_id, wherein s_id is an index of the first Orthogonal Frequency Division Multiplexing, OFDM, symbol of the random access channel occasion, t_id is the index of the first slot of the random access channel occasion in a system frame, f_id is an index of the random access channel occasion in the frequency domain, and ul_carrier_id is an uplink carrier used for random access preamble transmission.

A10. The method of any of embodiments A5-A9, wherein the subcarrier spacing used to determine the index is smaller than a subcarrier spacing of the random access channel occasion, and wherein the first slot, from among multiple slots with the subcarrier spacing used to determine the index, that contains the random access channel occasion spans multiple slots with the subcarrier spacing of the random access channel occasion.

A11. The method of embodiment A10, wherein said computing comprises computing the random access identifier as a function also of an index of the first slot, from among the multiple slots with the subcarrier spacing of the random access channel occasion, containing the random access channel occasion.

A12. The method of embodiment A10, wherein said computing comprises computing the random access identifier as a function also of an index of the random access channel occasion in the first slot.

A13. The method of embodiment A10, wherein said computing comprises computing the random access identifier as a function also of an index of a random access channel configuration for transmitting the random access message.

A14. The method of embodiment A10, wherein said computing comprises computing the random access identifier as a function also of an index of the subcarrier spacing of the random access channel occasion.

A15. The method of embodiment A10, further comprising monitoring a downlink control channel for a random access response that is identified by the random access identifier and that is associated with signaling indicating an index of the first slot, from among the multiple slots with the subcarrier spacing of the random access channel occasion, containing the random access channel occasion.

A16. The method of embodiment A10, further comprising monitoring a downlink control channel for a random access response that is identified by the random access identifier and that is associated with signaling indicating an index of the random access channel occasion in the first slot.

A17. The method of embodiment A10, further comprising monitoring a downlink control channel for a random access response that is identified by the random access identifier and that is associated with signaling indicating a random access channel configuration of the random access message.

A18. The method of embodiment A10, further comprising monitoring a downlink control channel for a random access response that is identified by the random access identifier and that is associated with signaling indicating an index of the subcarrier spacing of the random access channel occasion.

A19. The method of any of embodiments A1-A18, wherein the random access message is MSGA of a two-step random access procedure or MSG1 of a four-step random access procedure.

A20. The method of any of embodiments A1-A19, wherein the random access message comprises a random access preamble.

A21. The method of any of embodiments A1-A20, wherein the random access channel occasion is a random access channel in which the wireless communication device transmits a random access preamble.

A22. The method of any of embodiments A1-A21, wherein the random access identifier is a Random Access Radio Network Temporary Identifier, RA-RNTI.

A23. The method of any of embodiments A1-A22, wherein said computing comprises computing the random access identifier as a function also of at least one of any one or more of:
an index of the first symbol of the random access channel occasion;
an index of the random access channel occasion in the frequency domain; and
an uplink carrier used for random access preamble transmission.

A24. The method of any of embodiments A1-A23, further comprising monitoring a downlink control channel for a random access response identified by the random access identifier.

A25. The method of any of embodiments A1-A24, further comprising, after transmitting the random access message, receiving, on a downlink control channel, a random access response identified by the random access identifier.

AA1. A method performed by a wireless communication device configured for use in a wireless communication network, the method comprising:
selecting, from among multiple subcarrier spacings configured for random access to a cell in the wireless communication network, a subcarrier spacing with which to perform random access to the cell; and
performing random access to the cell using the selected subcarrier spacing.

AA2. The method of embodiment AA1, wherein the subcarrier spacing is selected based on a service, application, or traffic type that triggered the random access to the cell.

AA3. The method of any of embodiments AA1-AA2, wherein the subcarrier spacing is selected based on a priority of a service, application, or traffic type that triggered the random access to the cell.

AA4. The method of embodiment AA3, wherein said selecting comprises:
if the service, application, or traffic type has a first priority, selecting a first subcarrier spacing with which to perform random access to the cell; and
if the service, application, or traffic type has a second priority, selecting a second subcarrier spacing with which to perform random access to the cell;
wherein the first priority is lower than the second priority, and wherein the first subcarrier spacing is lower than the second subcarrier spacing.

AA5. The method of any of embodiments AA3-AA4, wherein said priority is based on one or more of:
an application identifier;
an access class or access category of the wireless communication device;
a logical channel priority of a logic channel containing data for the service, application or traffic type;
a logical channel group identifier to which a logic channel containing data for the service, application or traffic type belongs;
a radio bearer identifier of a radio bearer used for the service, application, or traffic type; and
a session or flow identifier of a session or flow used for the service, application, or traffic type.

AA6. The method of any of embodiments AA1-AA5, wherein the subcarrier spacing is selected based on a quality of service requirement of a service, application, or traffic type that triggered the random access to the cell.

AA7. The method of embodiment AA6, wherein said selecting comprises:
if the service, application, or traffic type has a first quality of service requirement, selecting a first subcarrier spacing with which to perform random access to the cell; and
if the service, application, or traffic type has a second quality of service requirement, selecting a second subcarrier spacing with which to perform random access to the cell;
wherein the first quality of service requirement is lower than the second quality of service requirement, and wherein the first subcarrier spacing is lower than the second subcarrier spacing.

AA8. The method of embodiment AA7, wherein the second quality of service requirement requires lower latency than the first quality of service requirement.

AA9. The method of any of embodiments AA1-AA8, wherein the subcarrier spacing is selected based on a purpose for which random access to the cell is triggered.

AA10. The method of embodiment AA9, wherein said selecting comprises:
if random access to the cell is triggered for the purpose of initial access from a radio resource control idle state, selecting a first subcarrier spacing with which to perform random access to the cell; and
if random access to the cell is triggered for the purpose of handover or beam failure recovery, selecting a second subcarrier spacing with which to perform random access to the cell;
wherein the first subcarrier spacing is lower than the second subcarrier spacing.

AA11. The method of any of embodiments AA1-AA8, wherein the subcarrier spacing is selected based on a capability of the wireless communication device, an access class of the wireless communication device, or an access category of the wireless communication device.

AA12. The method of any of embodiments AA1-AA11, wherein the subcarrier spacing is selected based on a volume of data which triggered the random access to the cell.

AA13. The method of any of embodiments AA1-AA12, wherein the subcarrier spacing is selected based on a signal strength or quality measured for the wireless communication device.

AA14. The method of embodiment AA13, wherein said selecting comprises:
if the wireless communication device has a first signal strength or quality, selecting a first subcarrier spacing with which to perform random access to the cell; and
if the wireless communication device has a second signal strength or quality, selecting a second subcarrier spacing with which to perform random access to the cell;
wherein the first signal strength or quality is lower than the second signal strength or quality, and wherein the first subcarrier spacing is lower than the second subcarrier spacing.

AA15. The method of any of embodiments AA1-AA14, wherein the subcarrier spacing is selected based on a location of the wireless communication device.

AA16. The method of embodiment AA15, wherein said selecting comprises:
if the wireless communication device has a first location, selecting a first subcarrier spacing with which to perform random access to the cell; and
if the wireless communication device has a second location, selecting a second subcarrier spacing with which to perform random access to the cell;
wherein the first location is farther away from a serving radio network node of the wireless communication device than the second location, and wherein the first subcarrier spacing is lower than the second subcarrier spacing.

AA17. The method of any of embodiments AA1-AA16, wherein the subcarrier spacing is selected based on a remaining battery life of the wireless communication device.

AA18. The method of embodiment AA17, wherein said selecting comprises:
if the wireless communication device has a first remaining battery life, selecting a first subcarrier spacing with which to perform random access to the cell; and
if the wireless communication device has a second remaining battery life, selecting a second subcarrier spacing with which to perform random access to the cell;
wherein the first remaining battery life is lower than the second remaining battery life, and wherein the first subcarrier spacing is lower than the second subcarrier spacing.

AA19. The method of any of embodiments AA1-AA18, wherein the subcarrier spacing is selected based on a power class of the wireless communication device and/or a transmit power of the wireless communication device.

AA20. The method of embodiment AA19, wherein said selecting comprises:
if the wireless communication device has a first power class or a first transmit power, selecting a first subcarrier spacing with which to perform random access to the cell; and
if the wireless communication device has a second power class or a second transmit power, selecting a second subcarrier spacing with which to perform random access to the cell;
wherein the first power class is lower than the second power class and/or the first transmit power is lower than the second transmit power;
wherein the first subcarrier spacing is lower than the second subcarrier spacing.

AA21. The method of any of embodiments AA1-AA20, wherein said performing comprises performing at least one random access transmission to the cell using the selected subcarrier spacing.

AA22. The method of embodiment AA21, further comprising, after performing at least one random access transmission to the cell using the selected subcarrier spacing, performing at least one other random access transmission to the cell using a different subcarrier spacing.

AA23. The method of embodiment AA22, wherein the at least one random access transmission includes a transmission of a certain random access message, and wherein the at least one other random access transmission includes a re-transmission of the same random access message.

AA24. The method of embodiment AA22, wherein the at least one random access transmission includes a transmission of a certain random access message, and wherein the at least one other random access transmission includes a transmission of a different random access message in the same random access procedure.

AA25. The method of any of embodiments AA1-AA24, further comprising receiving a configuration or signaling from a network node in the wireless communication network, wherein the configuration or the signaling configures the subcarrier spacing that the wireless communication device is to select for performing the random access to the cell.

AAA1. A method performed by a wireless communication device configured for use in a wireless communication network, the method comprising:
receiving a configuration or signaling from a network node in the wireless communication network, wherein the configuration or the signaling configures a subcarrier spacing that the wireless communication device is to use for performing the random access to the cell; and
performing random access to the cell using the configured subcarrier spacing.

AA. The method of any of the previous embodiments, further comprising:
providing user data; and
forwarding the user data to a host computer via the transmission to a base station.

### Group B Embodiments

BB1. A method performed by a network node configured for use in a wireless communication network, the method comprising:
receiving a random access message transmitted by a wireless communication device using a random access channel occasion and a random access identifier; and
in response to the random access message, transmitting, on a downlink control channel,
   a random access response identified by the random access identifier and
   transmitting signaling indicating:
   an index of the first slot, from among multiple slots with a subcarrier spacing of the random access channel occasion, containing the random access channel occasion;
   an index of the random access channel occasion in the first slot;
   a random access channel configuration of the random access message; or
   an index of the subcarrier spacing of the random access channel occasion.

BB2. The method of embodiment BB1, wherein the subcarrier spacing of the random access channel occasion is different than a subcarrier spacing used to determine the random access identifier.

BB3. The method of embodiment BB2, wherein the subcarrier spacing of the random access channel occasion is higher than a subcarrier spacing used to determine the random access identifier.

BB4. The method of any of embodiments BB1-BB3, wherein the subcarrier spacing used to determine the random access identifier is 120 kHz and wherein the subcarrier spacing of the random access channel occasion is higher than 120 kHz.

BB5. The method of any of embodiments BB1-BB5, wherein the random access message is MSGA of a two-step random access procedure or MSG1 of a four-step random access procedure.

BB6. The method of any of embodiments BB1-BB5, wherein the random access message comprises a random access preamble.

BB7. The method of any of embodiments BB1-BB6, wherein the random access channel occasion is a random access channel in which the wireless communication device transmits a random access preamble.

BB8. The method of any of embodiments BB1-BB7, wherein the random access identifier is a Random Access Radio Network Temporary Identifier, RA-RNTI.

BB9. The method of any of embodiments BB1-BB8, wherein the random access identifier is a function of an index of the first slot of the random access channel occasion in a system frame, as determined using a subcarrier spacing different than the subcarrier spacing of the random access channel occasion.

BB10. The method of embodiment BB9, wherein the random access identifier is a function also of at least one of any one or more of:
an index of the first symbol of the random access channel occasion;
an index of the random access channel occasion in the frequency domain; and
an uplink carrier used for random access preamble transmission.

BB11. The method of any of embodiments BB1-BB10, wherein the random access identifier is equal to 1+s_id+14×t_id+14×80×f_id+14×80×8×ul_carrier_id, wherein s_id is an index of the first Orthogonal Frequency Division Multiplexing, OFDM, symbol of the random access channel occasion, t_id is the index of the first slot of the random access channel occasion in a system frame, wherein t_id is determined using a subcarrier spacing different than the subcarrier spacing of the random access channel occasion, f_id is an index of the random access channel occasion in the frequency domain, and ul_carrier_id is an uplink carrier used for random access preamble transmission.

BB12. The method of any of embodiments BB1-BB11, wherein a subcarrier spacing used to determine the index is smaller than the subcarrier spacing of the random access channel occasion, and wherein the first slot, from among multiple slots with the subcarrier spacing used to determine the index, that contains the random access channel occasion spans multiple slots with the subcarrier spacing of the random access channel occasion.

BB13. The method of any of embodiments BB1-BB12, wherein the signaling indicates an index of the first slot, from among the multiple slots with the subcarrier spacing of the random access channel occasion, containing the random access channel occasion.

BB14. The method of any of embodiments BB1-BB12, wherein the signaling indicates an index of the random access channel occasion in the first slot.

BB15. The method of any of embodiments BB1-BB12, wherein the signaling indicates a random access channel configuration of the random access message.

BB16. The method of any of embodiments BB1-BB12, wherein the signaling indicates an index of the subcarrier spacing of the random access channel occasion.

BBB1. A method performed by a network node configured for use in a wireless communication network, the method comprising:
transmitting, to a wireless communication device, a configuration or signaling that configures a subcarrier spacing that the wireless communication device is to select or use for performing the random access to the cell.

BB. The method of any of the previous embodiments, further comprising:
obtaining user data; and
forwarding the user data to a host computer or a wireless communication device.

### Group C Embodiments

C1. A wireless communication device configured to perform any of the steps of any of the Group A embodiments.

C2. A wireless communication device comprising processing circuitry configured to perform any of the steps of any of the Group A embodiments.

C3. A wireless communication device comprising:
communication circuitry; and
processing circuitry configured to perform any of the steps of any of the Group A embodiments.

C4. A wireless communication device comprising:
processing circuitry configured to perform any of the steps of any of the Group A embodiments; and
power supply circuitry configured to supply power to the wireless communication device.

C5. A wireless communication device comprising:
processing circuitry and memory, the memory containing instructions executable by the processing circuitry whereby the wireless communication device is configured to perform any of the steps of any of the Group A embodiments.

C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C7. A computer program comprising instructions which, when executed by at least one processor of a wireless communication device, causes the wireless communication device to carry out the steps of any of the Group A embodiments.

C8. A carrier containing the computer program of embodiment C7, wherein the carrier is one of an electronic signal, optical signal, radio signal, or computer readable storage medium.

C9. A network node configured to perform any of the steps of any of the Group B embodiments.

C10. A network node comprising processing circuitry configured to perform any of the steps of any of the Group B embodiments.

C11. A network node comprising:
communication circuitry; and
processing circuitry configured to perform any of the steps of any of the Group B embodiments.

C12. A network node comprising:
processing circuitry configured to perform any of the steps of any of the Group B embodiments;
power supply circuitry configured to supply power to the network node.

C13. A network node comprising:
processing circuitry and memory, the memory containing instructions executable by the processing circuitry whereby the network node is configured to perform any of the steps of any of the Group B embodiments.

C14. The network node of any of embodiments C9-C13, wherein the network node is a base station.

C15. A computer program comprising instructions which, when executed by at least one processor of a network node, causes the network node to carry out the steps of any of the Group B embodiments.

C16. The computer program of embodiment C14, wherein the network node is a base station.

C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

D2. The communication system of the previous embodiment further including the base station.

D3. The communication system of the previous 2 embodiments, further including the UE, wherein the UE is configured to communicate with the base station.

D4. The communication system of the previous 3 embodiments, wherein:
the processing circuitry of the host computer is configured to execute a host application, thereby providing the user data; and
the UE comprises processing circuitry configured to execute a client application associated with the host application.

D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

D6. The method of the previous embodiment, further comprising, at the base station, transmitting the user data.

D7. The method of the previous 2 embodiments, wherein the user data is provided at the host computer by executing a host application, the method further comprising, at the UE, executing a client application associated with the host application.

D8. A user equipment (UE) configured to communicate with a base station, the UE comprising a radio interface and processing circuitry configured to perform any of the previous 3 embodiments.

D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

D10. The communication system of the previous embodiment, wherein the cellular network further includes a base station configured to communicate with the UE.

D11. The communication system of the previous 2 embodiments, wherein:
the processing circuitry of the host computer is configured to execute a host application, thereby providing the user data; and
the UE's processing circuitry is configured to execute a client application associated with the host application.

D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

D13. The method of the previous embodiment, further comprising at the UE, receiving the user data from the base station.

D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

D15. The communication system of the previous embodiment, further including the UE.

D16. The communication system of the previous 2 embodiments, further including the base station, wherein the base station comprises a radio interface configured to communicate with the UE and a communication interface configured to forward to the host computer the user data carried by a transmission from the UE to the base station.

D17. The communication system of the previous 3 embodiments, wherein:
the processing circuitry of the host computer is configured to execute a host application; and
the UE's processing circuitry is configured to execute a client application associated with the host application, thereby providing the user data.

D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

D19. A method implemented in a communication system including a host computer, a base station and a user equipment (UE), the method comprising:
at the host computer, receiving user data transmitted to the base station from the UE, wherein the UE performs any of the steps of any of the Group A embodiments.

D20. The method of the previous embodiment, further comprising, at the UE, providing the user data to the base station.

D21. The method of the previous 2 embodiments, further comprising:
at the UE, executing a client application, thereby providing the user data to be transmitted; and
at the host computer, executing a host application associated with the client application.

D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

D24. The communication system of the previous embodiment further including the base station.

D25. The communication system of the previous 2 embodiments, further including the UE, wherein the UE is configured to communicate with the base station.

D26. The communication system of the previous 3 embodiments, wherein:
the processing circuitry of the host computer is configured to execute a host application;
the UE is configured to execute a client application associated with the host application, thereby providing the user data to be received by the host computer.

D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

D28. The method of the previous embodiment, further comprising at the base station, receiving the user data from the UE.

D29. The method of the previous 2 embodiments, further comprising at the base station, initiating a transmission of the received user data to the host computer.

1.-31. (canceled)

32. A method performed by a wireless communication device configured for use in a wireless communication network, the method comprising:
computing a random access identifier associated with a random access channel occasion as a function of an index of the first slot of the random access channel occasion in a system frame, wherein a subcarrier spacing used to determine the index is different than a subcarrier spacing of the random access channel occasion;
transmitting a random access message using the random access channel occasion and the computed random access identifier.

33. The method of claim 32, wherein the subcarrier spacing used to determine the index is smaller than a subcarrier spacing of the random access channel occasion.

34. The method of claim 32, wherein a subcarrier spacing used to determine the index is 120 kHz.

35. The method of claim 32, wherein said computing comprises computing the random access identifier as 1+s_id+14×t_id+14×80×f_id+14×80×8×ul_carrier_id, wherein s_id is an index of the first Orthogonal Frequency Division Multiplexing (OFDM) symbol of the random access channel occasion, t_id is the index of the first slot of the random access channel occasion in a system frame, f_id is an index of the random access channel occasion in the frequency domain, and ul_carrier_id is an uplink carrier used for random access preamble transmission.

36. The method of claim 32, wherein the subcarrier spacing used to determine the index is smaller than a subcarrier spacing of the random access channel occasion, and wherein the first slot, from among multiple slots with the subcarrier spacing used to determine the index, that contains the random access channel occasion spans multiple slots with the subcarrier spacing of the random access channel occasion.

37. The method of claim 36, wherein said computing comprises computing the random access identifier as a function also of an index of the first slot, from among the multiple slots with the subcarrier spacing of the random access channel occasion, containing the random access channel occasion.

38. The method of claim 37, wherein said computing comprises computing the random access identifier as a function also of:
an index of the random access channel occasion in the first slot;
an index of a random access channel configuration for transmitting the random access message; or
an index of the subcarrier spacing of the random access channel occasion.

39. The method of claim 37, further comprising monitoring a downlink control channel for a random access response that is identified by the random access identifier and that is associated with signaling indicating an index of the first slot, from among the multiple slots with the subcarrier spacing of the random access channel occasion, containing the random access channel occasion.

40. The method of claim 37, further comprising monitoring a downlink control channel for a random access response that is identified by the random access identifier and that is associated with signaling indicating:
an index of the random access channel occasion in the first slot;
a random access channel configuration of the random access message; or
an index of the subcarrier spacing of the random access channel occasion.

41. The method of claim 32, wherein the random access identifier is a Random Access Radio Network Temporary Identifier (RA-RNTI).

42. The method of claim 32, further comprising monitoring a downlink control channel for a random access response identified by the random access identifier.

43. The method of claim 32, further comprising, after transmitting the random access message, receiving, on a downlink control channel, a random access response identified by the random access identifier.

44. A method performed by a network node configured for use in a wireless communication network, the method comprising:
receiving a random access message transmitted by a wireless communication device using a random access channel occasion and a random access identifier; and
in response to the random access message, transmitting, on a downlink control channel, a random access response identified by the random access identifier, wherein a subcarrier spacing of the random access channel occasion is different than a subcarrier spacing used to determine the random access identifier.

45. The method of claim 44, wherein a subcarrier spacing used to determine the random access identifier is smaller than the subcarrier spacing of the random access channel occasion.

46. The method of claim 44, wherein a first slot, from among multiple slots with the subcarrier spacing used to determine the random access identifier, that contains the random access channel occasion spans multiple slots with the subcarrier spacing of the random access channel occasion.

47. The method of claim 44, wherein the subcarrier spacing used to determine the random access identifier is 120 kHz and wherein the subcarrier spacing of the random access channel occasion is higher than 120 kHz.

48. The method of claim 44, wherein the random access identifier is a Random Access Radio Network Temporary Identifier (RA-RNTI).

49. The method of claim 44, wherein the random access identifier is a function of an index of the first slot of the random access channel occasion in a system frame.

50. The method of claim 44, wherein the random access identifier is equal to 1+s_id+14×t_id+14×80×f_id+14×80×8×ul_carrier_id, wherein s_id is an index of the first Orthogonal Frequency Division Multiplexing (OFDM) symbol of the random access channel occasion, t_id is the index of the first slot of the random access channel occasion in a system frame, wherein t_id is determined using a subcarrier spacing different than the subcarrier spacing of the random access channel occasion, f_id is an index of the random access channel occasion in the frequency domain, and ul_carrier_id is an uplink carrier used for random access preamble transmission.

51. The method of claim 44, further comprising transmitting signaling indicating:
an index of the first slot, from among multiple slots with a subcarrier spacing of the random access channel occasion, containing the random access channel occasion;
an index of the random access channel occasion in the first slot of the random access channel occasion in a system frame;
a random access channel configuration of the random access message; or
an index of the subcarrier spacing of the random access channel occasion.

52. A wireless communication device configured for use in a wireless communication network, the wireless communication device comprising:
communication circuitry; and
processing circuitry configured to:
compute a random access identifier associated with a random access channel occasion as a function of an index of the first slot of the random access channel occasion in a system frame, wherein a subcarrier spacing used to determine the index is different than a subcarrier spacing of the random access channel occasion;
transmit a random access message using the random access channel occasion and the computed random access identifier.

53. A network node configured for use in a wireless communication network, the network node comprising:
communication circuitry; and
processing circuitry configured to:
receive a random access message transmitted by a wireless communication device using a random access channel occasion and a random access identifier; and
in response to the random access message, transmit, on a downlink control channel, a random access response identified by the random access identifier, wherein a subcarrier spacing of the random access channel occasion is different than a subcarrier spacing used to determine the random access identifier.
